(19) United States
(12) Patent Application Publication
(10) Pub. No.: US 2013/0068133 A1
(43) Pub. Date: Mar. 21, 2013

(54) CELLULOSE ESTER FILM, POLARIZING PLATE AND LIQUID CRYSTAL DISPLAY DEVICE

(71) Applicants: Shusuke ARITA, Kanagawa (JP); Hirofumi TOYAMA, Kanagawa (JP); Junichi SATO, Kanagawa (JP); Eiichiro AMINAKA, Kanagawa (JP)

(72) Inventors: Shusuke ARITA, Kanagawa (JP); Hirofumi TOYAMA, Kanagawa (JP); Junichi SATO, Kanagawa (JP); Eiichiro AMINAKA, Kanagawa (JP)

(73) Assignee: FUJIFILM CORPORATION, Tokyo (JP)

(21) Appl. No.: 13/612,250

(22) Filed: Sep. 12, 2012

(30) Foreign Application Priority Data
Sep. 16, 2011 (JP) 2011-203407
Mar. 28, 2012 (JP) 2012-074573

(51) Int. Cl. C08L 1/10

(52) U.S. Cl. 106/170.29; 524/37

(57) ABSTRACT

A cellulose ester film includes at least one polyester; and a cellulose ester having a degree of substitution of 2.0 to 2.6. A weight average molecular weight of the polyester is 1,500 or less, and a ratio of components having a molecular weight of 500 or less in the polyester is less than 8%.

This application is based on and claims priority under 35 U.S.C. §119 from Japanese Patent Application Nos. 2011-203407 and 2012-074573, filed Sep. 16, 2011 and Mar. 28, 2012, respectively, the entire disclosures of which are herein incorporated by reference.

### BACKGROUND OF THE INVENTION

1. Field of the Invention

The present invention relates to a cellulose ester film that can be manufactured without contaminating the inside of a manufacturing device and has suppressed defects of film surface or bleed-out, and a polarizing plate and a liquid crystal display device using the cellulose ester film.

2. Background Art

Films of polymers typified by cellulose esters, polyesters, polycarbonates, cycloolefin polymer, vinyl polymers, polyimides, and the like are used in silver halide photographic light-sensitive materials, retardation films (phase difference films), polarizing plates, and image display devices. From these polymers, films which are excellent in flatness and uniformity can be prepared, and thus are widely employed as films in optical applications.

Among these them, it is possible for a cellulose ester film having an appropriate moisture vapor permeability to be online directly attached to a polarizer including polyvinyl alcohol (PVA)/iodine, which is most commonly used. Therefore, in particular, a cellulose acetate film is widely employed as a protective film of a polarizing plate.

When these films are used in optical applications such as a retardation film, a support of a retardation film, a protective film of a polarizing plate, and a liquid crystal display device, controlling the optical anisotropy is a very important factor in determining the display device performance (for example, visibility). With the recent demand for enhancing the viewing angle of liquid crystal display devices, improvement of retardation compensation has been desired, and the retardation value in an in-plane direction (Re; hereinafter, may be simply referred to as “Rth”) and the retardation value in a thickness direction (Rth; hereinafter, may be simply referred to as “Rth”), of a retardation film disposed between a polarizer and a liquid crystal cell, are required to be appropriately controlled. For example, Patent Document 1 (Japanese Patent Application Laid-Open No. 2007-178992) discloses a technology which allows a polyester compound including divalent alcohol and dibasic acid to be contained in a cellulose acylate.

As for the control by such an additive, a technology regarding a cellulose ester film, which contains polyester having a weight average molecular weight of 20,000 or less, is disclosed in Patent Document 2 (WO 07/000,910 A corresponding to US 2007/0048462 A1).

### SUMMARY OF THE INVENTION

However, when the polyesters disclosed in the Patent Documents 1 and 2 are used, a process contamination or the defects of film surface may be generated by the polyester-derived volatile matters. Therefore, the volatile matters need to be suppressed to maintain a high productivity.

Therefore, in order to solve the above-mentioned problems, the present inventors have studied to provide a cellulose ester film and a polarizing plate, which can suppress the process contamination and the defects of film surface caused by the polyester-derived volatile matters. As a result, it has been found out that the problem caused by the volatilization can be solved by adding a specific polyester in which a low molecular weight component is removed, as an additive to the cellulose ester film.

However, when a film was manufactured using the specific polyester as an additive, a problem became apparent in which the polyester as the additive was bleed-out under a raw material fluctuation condition (under a forced condition, in which larger amount of water than the designed amount is added in consideration of fluctuation of water contained in a material or a solvent).

An object of the present invention is to provide a cellulose ester film and a polarizing plate, in which the process contamination or defects of film surface caused by the polyester-derived volatile matters and the bleed-out are suppressed.

The present inventors have intensively studied to solve the problems, and as a result, it has been found out that the additive volatilization problem is resulted from the volatilization of the low molecular weight component in the additive. Namely, it has been found that the volatilization can be suppressed by removing the low molecular weight component in the additive because in the prescription containing the additive, the in-process contamination or the defects of film surface are generated by the volatilization of the low molecular weight component, and therefore, the film cannot be manufactured stably. Further, it has been also found out that the bleed-out is not generated even after removing the low molecular weight component by controlling the molecular weight before removing the molecules having low molecular weight to a certain value or less. By adding the polyester having specific molecular weight distribution controlled by the two methods of controlling the molecular weight, the generation of the in-process contamination or the defects of film surface may be suppressed while suppressing the bleed-out to complete the invention.

The present invention may be accomplished by the following means.

[1] A cellulose ester film including:

at least one polyester; and

a cellulose ester having a degree of substitution of 2.0 to 2.6,

wherein a weight average molecular weight of the polyester is 1,500 or less, and a ratio of components having a molecular weight of 500 or less in the polyester is less than 8%.

[2] The cellulose ester film of [1], wherein the polyester is a polycondensation ester of a mixture of an aromatic dicarboxylic acid and an aliphatic dicarboxylic acid; and an aliphatic diol.
[3] The cellulose ester film of [2], wherein each terminal of the polyester is an ester derivative of an aliphatic monocarboxylic acid.
[4] The cellulose ester film of [2] or [3], wherein the aliphatic diol has an average carbon atom number of 2 to 3.
[5] The cellulose ester film of any one of [2] to [4], wherein the aliphatic dicarboxylic acid has an average carbon atom number of 4 to 6, and a mixing ratio of the aromatic dicarboxylic acid in the mixture of an aromatic dicarboxylic acid and an aliphatic dicarboxylic acid is 20% by mass to 70% by mass.
[6] The cellulose ester film of any one of [1] to [5], wherein the cellulose ester is a cellulose acylate.
[7] The cellulose ester film of any one of [1] to [6], which satisfies a following Equation (I):

ΔRe>0

wherein ΔRe=Re(630)−Re(430) and Re(630) represents an in-plane retardation at the wavelength of 630 nm; and Re(430) represents an in-plane retardation at the wavelength of 430 nm.

[8] The cellulose ester film of any one of any one of [1] to [7], wherein an in-pane retardation at the wavelength of 590 nm (Re(590)) is 30 nm<Re(590)<100 nm, and a retardation in a thickness-direction at the wavelength of 590 nm (Rth(590)) is 80 nm<Rth(590)<300 nm.
[9] The cellulose ester film of any one of [1] to [8], which has a weight reduction rate of less than 0.4% when the cellulose ester film is kept at 180° C. for 1 hour.
[10] The cellulose ester film of any one of [1] to [9], which has an internal haze of 0.2% or less.
[11] The cellulose ester film of any one of [1] to [10], which includes at least one retardation developer.
[12] The cellulose ester film of [11], wherein the retardation developer includes a discotic compound, and the discotic compound is in an amount of less than 3 parts by mass based on 100 parts by mass of the cellulose ester.
[13] The cellulose ester film of [11] or [12], wherein the retardation developer includes an ester compound having 1 to 12 units of at least one of a pyranose structure and a furanose structure, in which a part of hydroxyl groups in the least one of the pyranose structure and the furanose structure is esterified, and the ester compound is in an amount of less than 15 parts by mass based on 100 parts by mass of the cellulose ester.
[14] A polarizing plate including a cellulose ester film of any one of [1] to [13].
[15] A liquid crystal display device including a polarizing plate of [14].

### DETAILED DESCRIPTION OF THE INVENTION

In a cellulose ester film of the present invention, the in-process contamination or the defects of film surface caused by the volatile matters derived from polyesters can be suppressed to further increase the productivity. In addition, the bleed-out under a raw material fluctuation condition can be suppressed (forced condition).

Hereinafter, the present invention will be described in detail. In the present specification, when a numerical value represents a physical property value, a characteristic value and the like, the description “(numerical value 1) to (numerical value 2)” refers to “(numerical value 1) or more and (numerical value 2) or less”.

The cellulose ester film of the present invention is a cellulose ester film including at least one kind of polyester and a cellulose ester film having a degree of substitution of 2.0 to 2.6. The weight average molecular weight of the polyester is 1,500 or less, and a ratio of components having a molecular weight of 500 or less in the polyester is less than 8%.

As described above, by adding the polyester having such a molecular weight distribution that the weight average molecular weight is 1,500 or less and the ratio of the components having a molecular weight of 500 or less is less than 8%, the in-process contamination or the defects of film surface caused by the volatile matters may be suppressed, and the bleed-out under a raw material fluctuation condition (forced condition) may also be suppressed.

[Polyester Additives]

Polyester used in the cellulose ester film of the present invention will be described.

The polyester may be obtained by any known method such as dehydration condensation reaction of a polybasic acid and a polyhydric alcohol, dehydration condensation reaction after addition of an anhydrous dibasic acid to the polyhydric alcohol and the like, and preferably, the polyester may be oligomers (in the present specification, called as “polycondensation ester”) including a polycondensation ester formed from the dibasic acid and a diol, and derivatives thereof.

Herein, the structure, the molecular weight and the amount of the polyester, as a dope of the cellulose ester and others compatible with the cellulose ester film, may be selected in a range having the above-described molecular weight distribution in order to satisfy the desired optical properties and other performances.

In the cellulose ester film of the present invention, a content of the polyester is preferably 30% by mass (by weight) or less, more preferably 5% by mass to 30% by mass, most preferably and 5% by mass to 20% by mass, based on the cellulose ester. If the content is 30% by mass or less, it is preferred to easily suppress bleed out from the film. If using 2 or more kinds of polyesters, it is preferable that the total content of the 2 or more kinds of polyesters is in the above-described range.

The weight average molecular weight (Mw) of the polyester of the present invention may be measured by gel permeation chromatography (GPC).

The weight average molecular weight of the polyester of the present invention is 1,500 or less, preferably 600 to 1,500, more preferably 800 to 1,500, and most preferably 1,000 to 1,500. By using the polyester having the weight average molecular weight of 1,500 or less, the bleed-out under the raw material fluctuation condition (forced condition) may be improved. If the weight average molecular weight is 600 or more, the volatilization of the polyester in a manufacturing process may be suppressed in combination with the following technique removing low molecular weight molecule.

In the polyester of the present invention, a ratio of components having molecular weight of 500 or less (weight fraction) is less than 8%, preferably less than 5%, and more preferably less than 3%. The ratio of the components having molecular weight of 500 or less may be measured by the gel permeation chromatography (GPC).

When forming the cellulose ester film, the volatilized component in the polyester is a low molecular weight ingredient. Therefore, as described above, the in-process contamination can be largely improved by using the polyester in which the ratio of the ingredient having low molecular weight of 500 or less is suppressed.

In order to control the ratio of the low molecular weight component to less than 8%, any method such as a distillation, for example, an ordinary vacuum distillation, a thin film (molecule) distillation and the like, a chromatography and the like may be used, and the thin film distillation is preferred, which can remove the low molecular weight component in a short time.

When the polyester is the above-described polycondensation ester, the dibasic acid making up the polycondensation ester is preferably a dicarboxylic acid.

The dicarboxylic acid may be an aliphatic dicarboxylic acid, an aromatic dicarboxylic acid and the like, and even either of them may be used. Specifically, a mixture of the aromatic dicarboxylic acid and the aliphatic dicarboxylic acid is preferably used.

Among the aromatic dicarboxylic acids, an aromatic carboxylic acid having 8 to 20 carbon atoms is preferable, and an aromatic dicarboxylic acid having 8 to 14 carbon atoms is more preferable. An aromatic dicarboxylic acid having 14 or less carbon atoms is preferred in view of the compatibility with the cellulose ester.

Specifically, the aromatic dicarboxylic acid may be an isophthalic acid, a terephthalic acid or a phthalic acid. The aromatic dicarboxylic acids may be used alone or in combinations of two or more kinds thereof. Among them, the terephthalic acid or the phthalic acid is preferable, and the terephthalic acid is more preferable.

The average carbon atom number of the aromatic dicarboxylic acid forming the polycondensation ester is preferably 8 to 20, more preferably 8 to 14. Herein, the “average” means a weighted average by mass ratio.

Among the aliphatic dicarboxylic acids, an aliphatic carboxylic acid having 3 to 8 carbon atoms is preferable, and an aliphatic dicarboxylic acid having 4 to 6 carbon atoms is more preferable. The aliphatic dicarboxylic acid having less carbon atoms can decrease the moisture vapor permeability of the cellulose ester film, and is suitable in view of the compatibility with the cellulose ester.

Specifically, exemplary compounds of the aliphatic dicarboxylic acid may be a succinic acid, a maleic acid, an adipic acid, a glutaric acid or the like, and may be used alone or in combinations of two or more kinds thereof. The aliphatic dicarboxylic acid is preferably the succinic acid, the adipic acid or a mixture thereof, and more preferably the succinic acid.

The average carbon atom number of the aliphatic dicarboxylic acid forming the polycondensation ester is preferably 3 to 8, more preferably 4 to 6. Herein, the “average” means a weighted average by mass ratio.

In the mixture of the aliphatic dicarboxylic acid and the aromatic dicarboxylic acid, a mixing ratio (mass ratio) of the aromatic dicarboxylic acid is preferably 20% to 70%, more preferably 30% to 60%, and even more preferably 45% to 55%. The desired optical properties can be satisfied by containing the aromatic dicarboxylic acid within a range of 20% to 70% (for example, Re and Rth can be controlled).

The diol which forms polycondensation ester may be an aliphatic diol, an aromatic diol or the like, and the aliphatic diol is preferable.

Among the aliphatic diols, an aliphatic diol having 2 to 4 carbon atoms is preferable, and an aliphatic diol having 2 to 3 carbon atoms is more preferable. This is why the aliphatic diol having less carbon atoms is excellent in the compatibility with a cellulose ester dope or the cellulose ester film and in the resistance to the bleed out caused by high temperature and high humidity treatment.

For example, the aliphatic diol may be ethylene glycol, diethylene glycol, 1,2-proplylene glycol, 1,3-proplylene glycol, butylene glycol or the like, and may be used alone or in combinations of two or more kinds thereof. Preferably the aliphatic diol may be ethylene glycol, 1,2-proplylene glycol or 1,3-proplylene glycol.

The average carbon atom number of the aliphatic diol forming the polycondensation ester is preferably 2 to 4, and more preferably 2 to 3. Herein, the “average” means a weighted average by mass ratio.

In view of the effect of the present invention, the polyester of the present invention is preferably a polycondensation ester formed from a mixture of the aromatic dicarboxylic acid and the aliphatic dicarboxylic acid, and an aliphatic diol.

In the present invention, the both terminals of the polyester may be sealed upon reacting with a monocarboxylic acid. The monocarboxylic acid used for sealing is preferably an aliphatic monocarboxylic acid, more preferably an acetic acid, a propionic acid, a butanoic acid, a benzoic acid and derivatives thereof, even more preferably the acetic acid and the propionic acid, and most preferably the acetic acid.

<Cellulose Ester>

The cellulose ester used for the cellulose ester film of the present invention is an ester of a cellulose as a raw material and an acid, preferably a carboxylic acid ester (so called a cellulose acylate) having 2 to 22 carbon atoms, more preferably a lower carboxylic acid ester having 6 or less carbon atoms.

In the cellulose ester used for the cellulose ester film of the present invention, a degree of substitution (a degree of esterification of three hydroxyl groups in a repeating unit of the cellulose, the degree of substitution is 3.0 when all hydroxyl groups are esterified) is preferably 2.0 to 2.6. The degree of substitution is more preferably 2.2 to 2.6, and even more preferably 2.35 to 2.50.

Examples of the cellulose used as a raw material of the cellulose ester in the present invention include cotton linter, wood pulp (broad leaf pulp and needle leaf pulp) and the like. The cellulose ester obtained from any raw cellulose may be used and, if necessary, may be used in a mixture thereof. Detailed description on these raw celluloses can be found in, for example, “Lecture on Plastic Materials (17) Cellulose Resins” (Maruzawa and Uda, The NIKKAN KOGYO SHIMBUN, Ltd., published in 1970) or Japan Institute of Invention and Innovation, Journal of Technical Disclosure 2001-1745 (pp. 7 to 8).

As the cellulose ester, the cellulose acylate is preferable in view of ease of synthesis, cost, ease of substituent distribution control and the like.

(Cellulose Acylate)

The β-1,4 bonding glucose unit constituting cellulose contains free hydroxyl groups at 2-, 3- and 6-positions. Cellulose acylate is a polymer prepared by subjecting a part or the whole of these hydroxyl groups to further esterification with an acyl group having two carbon atoms or more. The degree of acyl substitution means the ratio of esterified hydroxyl groups in cellulose at each of 2-, 3- and 6-positions (100% esterification is defined as a degree of substitution of 3).

The total degree of acyl substitution, that is, DS2+DS3+DS6 is 2.0 to 2.6, preferably 2.1 to 2.6, more preferably 2.2 to 2.6, and even more preferably 2.35 to 2.50. DS6/(DS2+DS3+DS6) is preferably 0.08 to 0.66, more preferably 0.15 to 0.60, and even more preferably 0.20 to 0.45. Herein, the DS2 is a degree of substitution of hydroxyl groups at 2-position of the glucose unit with acyl groups (hereinafter, also referred to as “degree of acyl substitution at 2-position”), the DS3 is a degree of substitution of hydroxyl groups at 3-position with acyl groups (hereinafter, also referred to as “degree of acyl substitution at 3-position”), and the DS6 is a degree of substitution of hydroxyl groups at 6-position with acyl groups (hereinafter, also referred to as “degree of acyl substitution at 6-position”). DS6/(DS2+DS3+DS6) indicates the ratio of the degree of acyl substitution at 6-position to the total degree of acyl substitution, and hereinafter, will be also referred to as “ratio of acyl substitution at 6-position”.

The acyl group of the cellulose acylate may be a single group, or a mixture of two or more kinds thereof. The cellulose acylate may have an acyl group having 2 to 4 carbon atoms as the substituent. When two or more kinds of acyl groups are used, one of them may be an acetyl group, and the other of them may be a propionyl group or a butyryl group. The sum total of the degree of substitution of hydroxyl groups at 2-, 3- and 6-positions with acetyl groups is referred to as DSA, and the sum total of the degree of substitution of hydroxyl groups at 2-, 3- and 6-positions with propionyl groups or butyryl groups is referred to as DSB. The value of DSA+DSB is 2.0 to 2.6, and preferably 2.1 to 2.6. More preferably, the value of DSA+DSB is 2.2 to 2.6 and the value of DSB is 0.10 to 1.70. And even more preferably, the value of DSA+DSB is 2.35 to 2.50 and the value of DSB is 0.5 to 1.2. When the values of DSA and DSB are defined to fall within the above ranges, it is favorable since a film having somewhat large wavelength dispersion can be obtained.

At least 28% of DSB is a substituent of the hydroxyl group at 6-position; more preferably, at least 30% thereof is a substituent of the hydroxyl group at 6-position; even more preferably, at least 31% thereof is a substituent of the hydroxyl group at 6-position; most preferably, at least 32% thereof is a substituent of the hydroxyl group at 6-position. These film ensures that it is possible to produce a solution for the preparation of a film which the film has good solubility and also to produce a good solution having a low viscosity and hence good filterability in case of, particularly, non-chlorine type organic solvents.

The acyl group having 2 or more carbon atoms of the cellulose acylate of the present specification may be an aliphatic group or an aryl group, and is not particularly limited. The cellulose ester having the acyl group may be an alkyl carbonyl ester of cellulose, an alkenyl carbonyl ester of cellulose or an aromatic carbonyl ester of cellulose, and may further have a substituent, respectively. Preferred examples of the substituent may include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group and a cinnamoyl group. Of these, the acetyl group, the propionyl group, the butanoyl group, the dodecanoyl group, the octadecanoyl group, the tert-butanoyl group, the oleoyl group, the benzoyl group, the naphthylcarbonyl group and the cinnamoyl group are preferable, and the acetyl group, the propionyl group and the butanoyl group are more preferable.

The acyl group of the cellulose acylate in the present specification is preferably an acetyl group (when the cellulose acylate is a cellulose acetate).

In the acylation of the cellulose, when an acid anhydride or an acid chloride is used as an acylating agent, the organic solvent as a reaction solvent may be an organic acid such as an acetic acid, or a methylene chloride or the like.

When the acylating agent is the acid anhydride, a protic catalyst such as sulfuric acid is preferably used as a catalyst, and when the acylating agent is the acid chloride (for example, CH₃CH₂COCl), a basic compound may be used as the catalyst.

The most popular industrial synthesizing method for a mixed fatty acid ester of the cellulose includes acylating the cellulose with a fatty acid corresponding to the acetyl group and other acyl groups (e.g., an acetic acid, a propionic acid, a valeric acid and the like), or with a mixed organic acid component containing acid anhydride of the fatty acid.

The cellulose acylate used in the present invention may be synthesized, for example, according to a method described in Japanese Patent Application Laid-Open No. H10-45804.

In the present invention, the wavelength dispersion property of the retardation in the cellulose ester film may be improved by using the cellulose ester having a low degree of substitution of 2.0 to 2.6 as described above.

<Other Additives>

In addition to the above-described polyester, for example, retardation controlling agents (retardation developers, retardation reducing agents); plasticizers such as phthalate ester, phosphate ester and the like; ultraviolet (UV) absorbers; antioxidants; matting agents and the like can be added to the film of the present invention.

In the present invention, as the retardation reducing agent, phosphate ester-based compounds or other compounds known as the additives of the cellulose ester film besides the polyester may be widely employed.

A polymer-based retardation reducing agent may be selected from a group consisting of phosphate ester-based polymers, stylene-based polymers, acryl-based polymers and copolymers thereof, and the acryl-based polymers and the stylene-based polymers are preferred. At least one kind of polymer having negative intrinsic birefringence, such as the stylene-based polymer and the acryl-based polymer, is preferably included in the retardation reducing agent.

Low molecular weight retardation reducing agents as the compound besides the polyester are as follows. These may be either solid or oily. That is, the melting point or boiling point thereof is not particularly limited. For example, mixing of a UV absorbing material having melting point of 20° C. or lower and a UV absorbing material having melting point of 20° C. or higher may be carried out, or mixing of degradation inhibitors having different melting points may be carried out. Infrared absorbing dyes are described, for example, in Japanese Patent Application Laid-Open No. 2001-194522. The addition can be carried out at any time in the manufacturing process of a cellulose acylate solution (dope). However, the addition may be performed by further including a process for adding additives to the final preparation process in the dope preparation process to prepare the dope solution. The amount of each material to be added is not particularly limited as long as functions are developed.

As the low molecular weight retardation reducing agent, a compound except the polyester is not particularly limited, and the details are listed in Japanese Patent Application Laid-Open No. 2007-272177, paragraphs [0066] to [0085].

The compounds represented by Formula (1) listed in Japanese Patent Application Laid-Open No. 2007-272177, paragraphs [0066] to [0085] may be prepared by the following method.

The compounds of Formula (1) in the above-described publication may be obtained by a condensation reaction of sulfonyl chloride derivatives and amine derivatives.

The compounds of Formula (2) listed in Japanese Patent Application Laid-Open No. 2007-272177 may be obtained by a dehydration condensation reaction of carboxylic acids and amines using a condensing agent (for example, dicyclohexyl carboimide (DCC) and the like), a substitution reaction of carboxylic acid chloride derivatives and amine derivatives, or the like.

The retardation reducing agents described as above are more preferably an Rth reducing agent, in view of realizing a proper Nz factor. Among the above-described retardation reducing agents, the Rth reducing agent may be an acryl-based polymer, a stylene-based polymer, low molecular weight compounds of Formulae (3) to (7) or the like. Among them, the acryl-based polymer and the stylene-based polymer are preferable, and the acryl-based polymer is more preferable.

The retardation reducing agent is preferably added in an amount of 0.01% by mass to 30% by mass, more preferably 0.1% by mass to 20% by mass, and even more preferably 0.1% by mass to 10% by mass, based on the cellulose-based resin.

When the amount of the retardation reducing agent to be added is 30% by mass or less, the compatibility with the cellulose-based resin may be increased, and therefore whitening may be suppressed. When two or more kinds of retardation reducing agents are used, total amount thereof would be preferably in the above-described ranges.

(Plasticizer)

The plasticizer used in the present invention may be any compound known as a plasticizer of the cellulose ester. The plasticizer may be a phosphate ester or a carboxylic acid ester. Examples of the phosphate ester may include triphenyl phosphate (TPP) and tricredyl phosphate (TCP). Representative examples of the carboxylic acid ester may include a phthalic acid ester and a citric acid ester. Examples of the phthalic acid ester may include dimethylphtahlate (DMP), diethylphtahlate (DEP), dibutylphtahlate (DBP), dioctylphtahlate (DOP), diphenylphtahlate (DPP) and diethylhexylphtahlate (DEHP). Examples of the citric acid ester may include triethyl O-acetylcitrate (OACTE) and tributyl O-acetylcitrate (OACTB). Other examples of carboxylic acid ester may include butyl oleate, methylacetyl ricinoleate, dibutyl sebacate, and various trimellitate esters. Phthalic acid ester-based plasticizers (DMP, DEP, DBP, DOP, DPP, and DEHP) are preferably used, and the DEP and the DPP are particularly preferable.

(Retardation Developer)

The film of the present invention may preferably include at least one retardation developer in the cellulose ester in order to develop a retardation value. The retardation developer may include rod-shaped compounds, compounds having a cyclic structure such as a cycloalkane or aromatic ring, and the compounds showing the ability to enhance retardation among the above-mentioned polyester-based compounds or ester compounds having 1 to 12 units of at least one of a pyranose structure and a furanose structure, in which a part of hydroxyl group in the structure is esterified, described later. But the retardation developer is not particularly limited thereto. As a compound having a cyclic structure, discotic compounds are preferred. Of the rod-shaped compounds or the discotic compounds, those having at least two aromatic rings are preferred for use as the retardation developer.

The amount of the retardation developer of the rod-shaped compounds to be added is preferably 0.1 parts to 30 parts by mass, and more preferably 0.5 parts to 20 parts by mass, based on 100 parts by mass of the cellulose acylate-containing polymer component. The amount of the discotic compound to be added, contained in the retardation developer, is preferably less than 3 parts by mass, more preferably less than 2 parts by mass, and particularly preferably less than 1 part by mass, based on 100 parts by mass of the cellulose acylate. The amount of the ester compound having 1 to 12 units of at least one of a pyranose structure and a furanose structure contained in the retardation developers, in which a part of hydroxyl group in the structure is esterified, is preferably less than 15 parts by mass, more preferably less than 12 parts by mass, and even more preferably less than 10 parts by mass, based on 100 parts by mass of the cellulose ester.

The discotic compound is superior to the rod-shaped compound as an Rth retardation developer, and is therefore favorably used in a case where the film requires and especially large Rth retardation. Two or more kinds of the retardation developers may be used, as combined.

Preferably, the retardation developer has the maximum absorption in a wavelength range of 250 nm to 400 nm, and preferably, it does not have substantial absorption in a visible light range.

(Discotic Compound)

As the discotic compound, any compound having at least two aromatic rings may be used.

In the present specification, the “aromatic ring” includes an aromatic heterocyclic ring in addition to an aromatic hydrocarbon ring.

The aromatic hydrocarbon ring is particularly preferably a 6-membered ring (that is, benzene ring).

The aromatic heterocyclic ring is generally an unsaturated heterocyclic ring. The aromatic heterocyclic ring is preferably a 5-membered ring, a 6-membered ring or a 7-membered ring, more preferably the 5-membered ring or the 6-membered ring. The aromatic heterocyclic ring generally has the largest number of double bonds. As heteroatoms, a nitrogen atom, an oxygen atom and a sulfur atom are preferred, and the nitrogen atom is particularly preferred. Examples of the aromatic heterocyclic ring may include a furan ring, a thiophene ring, a pyrrole ring, an oxazole ring, an iso-oxazole ring, a thiazole ring, an iso-thiazole ring, and imidazole ring, a pyrazole ring, a furazane ring, a triazole ring, a pyran ring, a pyridine ring, a pyridazine ring, a pyrimidine ring, a pyrazine ring and a 1,3,5-triazine ring.

The aromatic ring is preferably a benzene ring, a condensed benzene ring or non-phenyls. The 1,3,5-triazine ring is more preferable. Specifically, for example, the compounds listed in Japanese Patent Application Laid-Open No. 2001-166144 are preferably used.

The carbon atom number in the aromatic ring of the retardation developer is preferably 2 to 20, more preferably 2 to 12, even more preferably 2 to 8, and most preferably 2 to 6.

The bond relation of the two aromatic rings can be classified into following cases (since an aromatic ring, a Spiro bond cannot be formed): (a) formation of a condensed ring, (b) formation of a direct bond by a single bond, and (c) formation of a bond via a linking group. The bond relation may be any one of (a) to (c).

Examples of the condensed ring of (a) (a condensed ring of two or more of aromatic rings) include an indene ring, a naphthalene ring, an azulene ring, a fluorene ring, a phenanthrene ring, an anthracene ring, an acenaphthylene ring, an biphenylene ring, a naphthacene ring, a pyrene ring, an indole ring, an iso-indole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and a thianthrene ring. The naphthalene ring, the azulene ring, the indole ring, the benzoxazole ring, the benzothiazole ring, the benzoimidazole ring, the benzotriazole ring and the quinoline ring are preferred.

The single bond of (b) is preferably a carbon-carbon bond between two aromatic rings. The two aromatic rings may be bonded by two or more of single bonds to form an aliphatic ring or a non-aromatic heterocyclic ring between the two aromatic rings.

The linking group of (c) also bonds, preferably, to carbon atoms of the two aromatic rings. The linking group is preferably an alkylene group, an alkenylene group, an alkynylene group, —CO—, —O—, —NH—, —S— or combinations thereof. Examples of the linking group composed of the combination are shown below. In this connection, the relation of right and left in the following examples of linking group may be reversed.

c1: —CO—O—

c2: —CO—NH—

c3: -alkylene-O—

c4: —NH—CO—NH—

c5: —NH—CO—O—

c6: —O—CO—O—

c7: —O-alkylene-O—

c8: —CO-alkenylene-

c9: —CO-alkenylene-NH—

c10: —CO-alkenylene-O—

c11: -alkylene-CO—O-alkylene-O—CO-alkylene-

c12: —O-alkylene-CO—O-alkylene-O—CO-alkylene-O—

c13: —O—CO-alkylene-CO—O—

c14: —NH—CO-alkenylene-

c15: —O—CO-alkenylene

The aromatic ring and the linking group may have a substituent.

Examples of the substituent may include a halogen atom (F, Cl, Br, I), a hydroxyl group, a carboxyl group, a cyano group, an amino group, a nitro group, a sulfo group, a carbamoyl group, a sulfamoyl group, a ureido group, an alkyl group, an alkenyl group, an alkynyl group, an aliphatic acyl group, an aliphatic acyloxy group, an alkoxy group, an alkoxycarbonyl group, an alkoxycarbonyl amino group, an alkylthio group, an alkylsulfonyl group, an aliphatic amide group, an aliphatic sulfonamide group, an aliphatic substituted amino group, an aliphatic substituted carbamoyl group, an aliphatic substituted sulfamoyl group, an aliphatic substituted ureido group and a non-aromatic heterocyclic group.

The carbon atom number of the alkyl group is preferably 1 to 8. A chain alkyl group is more preferable to a cyclic alkyl group, and a straight chain alkyl group is particularly preferred. The alkyl group may also have a substituent such as a hydroxyl group, a carboxyl group, an alkoxy group, and an alkyl substituted amino group. Examples of the alkyl group (including the substituted alkyl group) may include a methyl group, an ethyl group, an n-butyl group, an n-hexyl group, a 2-hydroxyethyl group, a 4-carboxybutyl group, a 2-methoxyethyl group and a 2-diethylaminoethyl group.

The carbon atom number of the alkenyl group is preferably 2 to 8. A chain alkenyl group is more preferable to a cyclic alkenyl group, and a straight chain alkenyl group is particularly preferred. The alkenyl group may also have a substituent. Examples of the alkenyl group may include a vinyl group, an allyl group and a 1-hexenyl group.

The carbon atom number of the alkynyl group is preferably 2 to 8. A chain alkynyl group is more preferable to a cyclic alkynyl group, and a straight chain alkynyl group is particularly preferred. The alkynyl group may also have a substituent. Examples of the alkynyl group may include an ethynyl group, a 1-butynyl group and a 1-hexynyl group.

The carbon atom number of the aliphatic acyl group is preferably 1 to 10. Examples of the aliphatic acyl group may include an acetyl group, a propanoyl group and a butanoyl group.

The carbon atom number of the aliphatic acyloxy group is preferably 1 to 10. Example of the aliphatic acyloxy group may include an acetoxy group.

The carbon atom number of the alkoxy group is preferably 1 to 8. The alkoxy group may also have a substituent (e.g., alkoxy group). Examples of the alkoxy group (including the substituted alkoxy group) may include a methoxy group, an ethoxy group, a butoxy group and a methoxyethoxy group.

The carbon atom number of the alkoxycarbonyl group is preferably 2 to 10. Examples of the alkoxycarbonyl group may include a methoxy carbonyl group and an ethoxy carbonyl group.

The carbon atom number of the alkoxycarbonyl amino group is preferably 2 to 10. Examples of the alkoxycarbonyl amino group may include a methoxycarbonyl amino group and an ethoxycarbonyl amino group.

The carbon atom number of the alkylthio group is preferably 1 to 12. Examples of the alkylthio group may include a methylthio group, an ethylthio group and an octylthio group.

The carbon atom number of the alkylsulfonyl group is preferably 1 to 8. Examples of the alkylsulfonyl group may include a methane sulfonyl group and an ethane sulfonyl group.

The carbon atom number of the aliphatic amide group is preferably 1 to 10. Example of the aliphatic amide group may include an acetamide.

The carbon atom number of the aliphatic sulfonamide group is preferably 1 to 8. Examples of the aliphatic sulfonamide group may include a methane sulfonamide group, a butane sulfonamide group and an n-octane sulfonamide group.

The carbon atom number of the aliphatic substituted amino group is preferably 1 to 10. Examples of the aliphatic substituted amino group may include a dimethylamino group, a diethylamino group and a 2-carboxyethylamino group.

The carbon atom number of the aliphatic substituted carbamoyl group is preferably 2 to 10. Examples of the aliphatic substituted carbamoyl group may include a methylcarbamoyl group and a diethylcarbamoyl group.

The carbon atom number of the aliphatic substituted sulfamoyl group is preferably 1 to 8. Examples of the aliphatic substituted sulfamoyl group may include a methylsulfamoyl group and a diethylsulfamoyl group.

The carbon atom number of the aliphatic substituted ureido group is preferably 2 to 10. Example of the aliphatic substituted ureido group may include a methylureido group.

The carbon atom number of the non-aromatic heterocyclic group may include a piperidino group and a morphorino group.

The molecular weight of the retardation developer is preferably 300 to 800.

The triazine compound represented by the following Formula (1) is preferably used for the discotic compound.

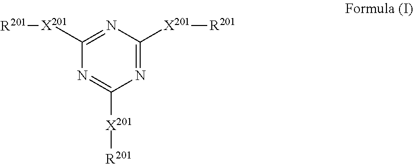

In Formula (1):

Each R²⁰¹ independently represents an aromatic ring or a heterocyclic ring having at least one substituent at any of the ortho-position, the meta-position and the para-position.

Each X²⁰¹ independently represents a single bond or —NR²⁰²—, wherein each R²⁰² independently represents a hydrogen atom, a substituted or unsubstituted alkyl group, an alkenyl group, an aryl group or a heterocyclic group.

The aromatic ring represented by the R²⁰¹ is preferably a phenyl ring or a naphthyl ring, and more preferably the phenyl ring. The aromatic ring represented by the R²⁰¹ may have at least one substituent at any one substitution position. Examples of the substituent may include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxy carbonyl group, an aryloxy carbonyl group, a sulfamoyl group, an alkyl substituted sulfamoyl group, an alkenyl substituted sulfamoyl group, an aryl substituted sulfamoyl group, a sulfonamide group, a carbamoyl group, an alkyl substituted carbamoyl group, an alkenyl substituted carbamoyl group, an aryl substituted carbamoyl group, an amide group, an alkylthio group, an alkenylthio group, an arylthio group and an acyl group.

The heterocyclic group represented by the R²⁰¹ may have aromaticity. The heterocycle having the aromaticity is generally an unsaturated heterocycle, and preferably a heterocycle having the largest number of double bonds. The heterocycle is preferably a 5-membered ring, a 6-membered ring or a 7-membered ring, more preferably the 5-membered ring or the 6-membered ring, and most preferably the 6-membered ring. The heteroatom of the heterocycle is preferably a nitrogen atom, a sulfur atom or an oxygen atom, and more preferably the nitrogen atom. The heterocycle having the aromaticity is most preferably a pyridine ring (the heterocyclic group thereof is a 2-pyridyl group or a 4-pyridyl group). The heterocyclic group may have a substituent. Examples of the substituent of the heterocyclic group may be the same as the examples of the substituents of the aryl moiety.

The heterocyclic group, in a case where X²⁰¹ is a single bond, is preferably a heterocyclic group having a free valency at the nitrogen atom. The heterocyclic group having a free valency at the nitrogen atom is preferably a 5-membered ring, a 6-membered ring or a 7-membered ring, more preferably a 5-membered ring or a 6-membered ring, most preferably a 5-membered ring. The heterocyclic group may have plural nitrogen atoms. The heterocyclic group may have any other heteroatom (for example, O, S) than the nitrogen atom. Examples of the heterocyclic group having a free valency at the nitrogen atom are shown below. Herein, —C₄H₉ⁿ represents n-C₄H₉.

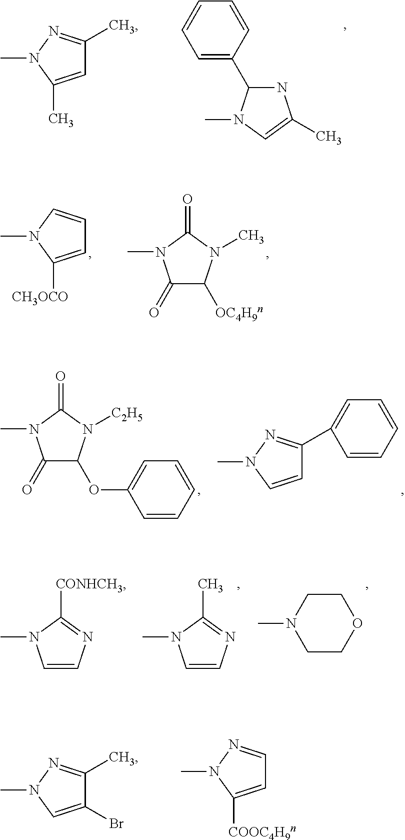

The alkyl group represented by the R²⁰² may be a cycloalkyl group or a chain alkyl group, preferably a chain alkyl group. A straight chain alkyl group is more preferred to a branched chain alkyl group. The carbon atom number of the alkyl group is preferably 1 to 30, more preferably 1 to 20, even more preferably 1 to 10, further more preferably 1 to 8, and most preferably 1 to 6. The alkyl group may also have a substituent. Examples of the substituent include a halogen atom, an alkoxy group (for example, a methoxy group, an ethoxy group) and an acyloxy group (for example, an acryloyloxy group, a methacryloyloxy group).

The alkenyl group represented by R²⁰² may be a cyclic alkenyl group or a chain alkenyl group, preferably a chain alkenyl group. A straight chain alkenyl group is more preferred to a branched chain alkenyl group. The carbon atom number of the alkenyl group is preferably 2 to 30, more preferably 2 to 20, even more preferably 2 to 10, further more preferably 2 to 8, and most preferably 2 to 6. The alkenyl group may have a substituent. Examples of the substituents are the same as those for the above-mentioned alkyl group.

The aromatic ring group and the heterocyclic group represented by R²⁰² and their preferable groups are those as described in R²⁰¹ above. The aromatic ring group and the heterocyclic group may have a substituent further, and examples of the substituent are the same as those for R²⁰¹.

The compounds represented by Formula (1) may be synthesized according to any known method, for example, the method described in Japanese Patent Application Laid-Open No. 2003-344655 and the like. The details of the retardation developer are described in Journal of Technical Disclosure, No. 2001-1745, page 49.

(Sugar Ester)

As the retardation developer of the present invention, for example, ester compounds having 1 to 12 units of at least one of a pyranose structure and a furanose structure contained in the retardation developers, in which a part of OH group in the structure is esterified, and/or a mixture thereof is preferably used.

The esterification ratio of the ester compound having 1 to 12 units of at least one of a pyranose structure and a furanose structure, in which the whole or a part of OH group in the structure is esterified, is preferably 70% or more of the OH group in the pyranose structure or the furanose structure.

In the present invention, the ester compound collectively will be also referred to as sugar esters or sugar ester compounds.

Examples of the ester compound used in the present invention are as follows, but not limited thereto.

The ester compound may be glucose, galactose, mannose, fructose, xylose, arabinose, lactose, sucrose, nystose, 1F-fructosyl nystose, stachyose, maltitol, lactitol, lactulose, cellobiose, maltose, cellotriose, maltotriose, raffinose or kestose.

In addition to these, gentiobiose, gentiotriose, gentiotetraose, xylotriose, galactosylsucrose, and the like may be further exemplified.

Among these compounds, compounds having both of a pyranose structure and a furanose structure are particularly preferred.

As an example, sucrose, kestose, nystose, 1F-fructosyl nystose and stachyose are preferred, and sucrose is more preferred.

Monocarboxylic acid used for esterification of the whole or a part of OH groups in the pyranose structure or the furanose structure is not particularly limited, and well known aliphatic monocarboxylic acids, cycloaliphatic monocarboxylic acids and aromatic monocarboxylic acids are available. The available carboxylic acids may be used either alone or in a mixture of two or more kinds thereof.

Preferred examples of the aliphatic monocarboxylic acids may include saturated fatty acids, such as an acetic acid, a propionic acid, a butyric acid, an isobutyric acid, a valeric acid, a caproic acid, an enanthic acid, a caprylic acid, a pelargonic acid, a capric acid, a 2-ethyl-hexane carboxylic acid, a undecylic acid, a lauric acid, a tridecylic acid, a myristic acid, a pentadecylic acid, a palmitic acid, a heptadecylic acid, a stearic acid, a nonadecane acid, an arachidic acid, a behenic acid, a lignoceric acid, a cerotinic acid, a heptacosanoic acid, a montanic acid, a melissic acid, a lacceric acid, and the like; and unsaturated fatty acids, such as a undecylenic acid, an oleic acid, a sorbic acid, a linoleic acid, a linolenic acid, an arachidonic acid, an octenoic acid and the like.

Preferred examples of the cycloaliphatic monocarboxylic acid may include an acetic acid, a cyclopentane carboxylic acid, a cyclohexane carboxylic acid, a cyclooctane carboxylic acid or a derivative thereof.

Preferred examples of the aromatic monocarboxylic acid may include an aromatic monocarboxylic acid in which an alkyl group or an alkoxy group is introduced to a benzene ring of benzoic acid, such as benzoic acid and toluic acid; an aromatic monocarboxylic acid having at least two benzene rings, such as a cinnamic acid, a benzilic acid, a biphenyl carboxylic acid, a naphthalene carboxylic acid, a tetralin carboxylic acid, and the like, or derivatives thereof. More specifically, the examples thereof may include a xylylic acid, a hemellitic acid, a mesitylenic acid, a prehnitylic acid, a γ-isodurylic acid, a durylic acid, a mesitonic acid, a α-isodurylic acid, a cuminic acid, a a-toluic acid, a hydroatropic acid, an atropic acid, a hydrocinnamic acid, a salicylic acid, an o-anisic acid, a m-anisic acid, a p-anisic acid, a creosotic acid, an o-homosalicylic acid, a m-homosalicylic acid, a p-homosalicylic acid, an o-pyrocatechuic acid, a β-resorcylic acid, a vanillic acid, an isovanillic acid, a veratric acid, an o-veratric acid, a gallic acid, an asaronic acid, a mandelic acid, a homoanisic acid, a homovanillic acid, a homoveratric acid, an o-homoveratric acid, a phthalonic acid and a p-coumaric acid. The benzoic acid and naphtyl acid are particularly preferable.

Esterified compounds of oligosaccharide also can be applied as the compounds having 1 to 12 units of at least one of a pyranose structure and a furanose structure.

The oligosaccharide is manufactured by acting an enzyme such as amylase and the like on starch, saccharose and the like, and examples of the oligosaccharide applicable in the present invention may include maltooligosaccharide, isomaltooligosaccharide, fructooligosaccharide, galactooligosaccharide and xylooligosaccharide.

Further, the ester compounds are a compound condensed with 1 to 12 units of at least one of pyranose structure or a furanose structure represented by the following Formula (A), wherein each of R₁₁ to R₁₅ and R₂₁ to R₂₅ independently represents an acyl group having 2 to 22 carbon atoms or a hydrogen atom; each of m and n independently represents an integral number of 0 to 12; and m+n represents an integral number of 1 to 12.

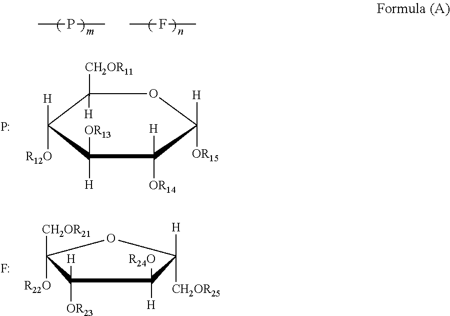

Preferably, each of R₁₁ to R₁₅ and R₂₁ to R₂₅ independently may be a benzoyl group or a hydrogen atom. The benzoyl group may further have a substituent R₂₆, for example, an alkyl group, an alkenyl group, an alkoxy group or a phenyl group. These alkyl group, alkenyl group and the phenyl group may have a substituent. The oligosaccharide may be prepared according to the method applied to the ester compound of the present invention.

Hereinafter, specific examples of the ester compound according to the present invention will be described, but not limited thereto.

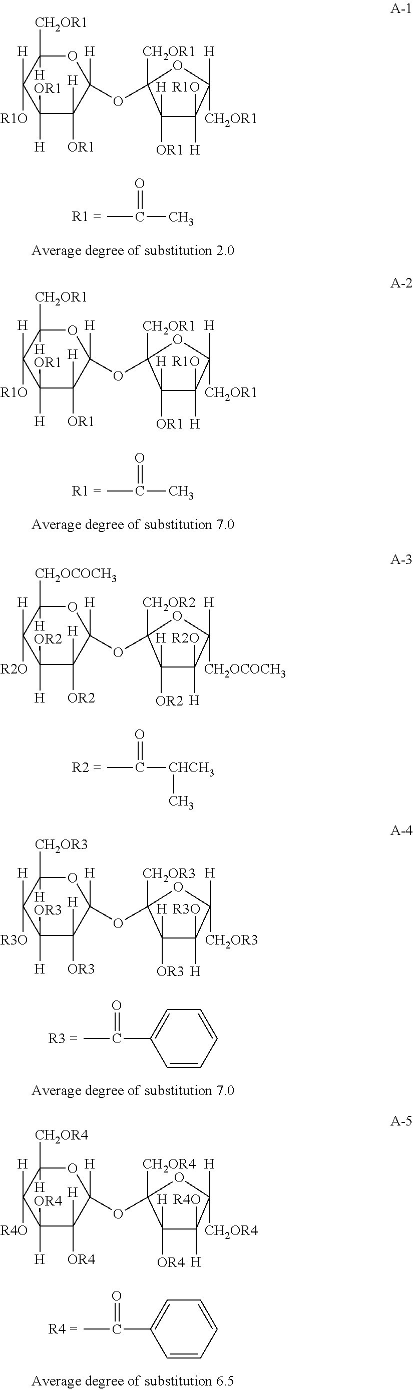

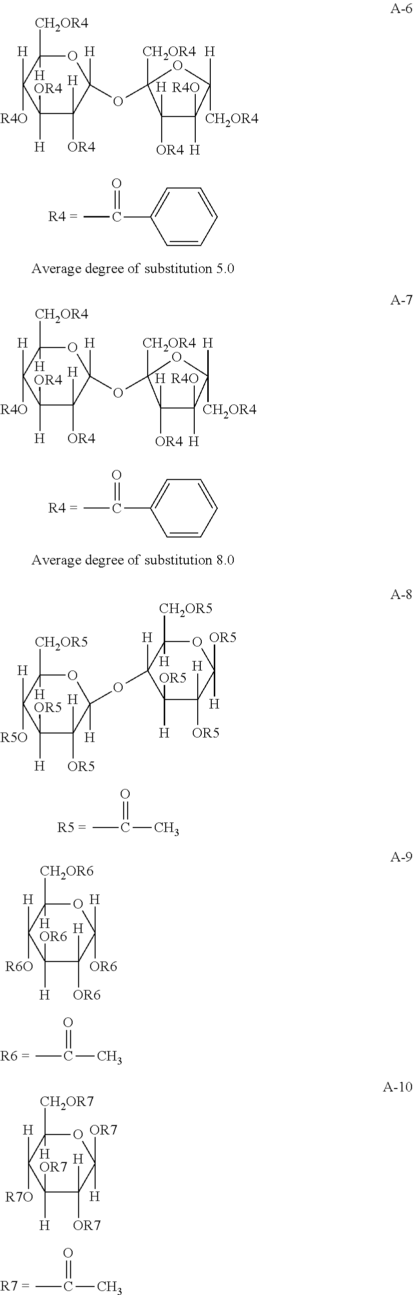

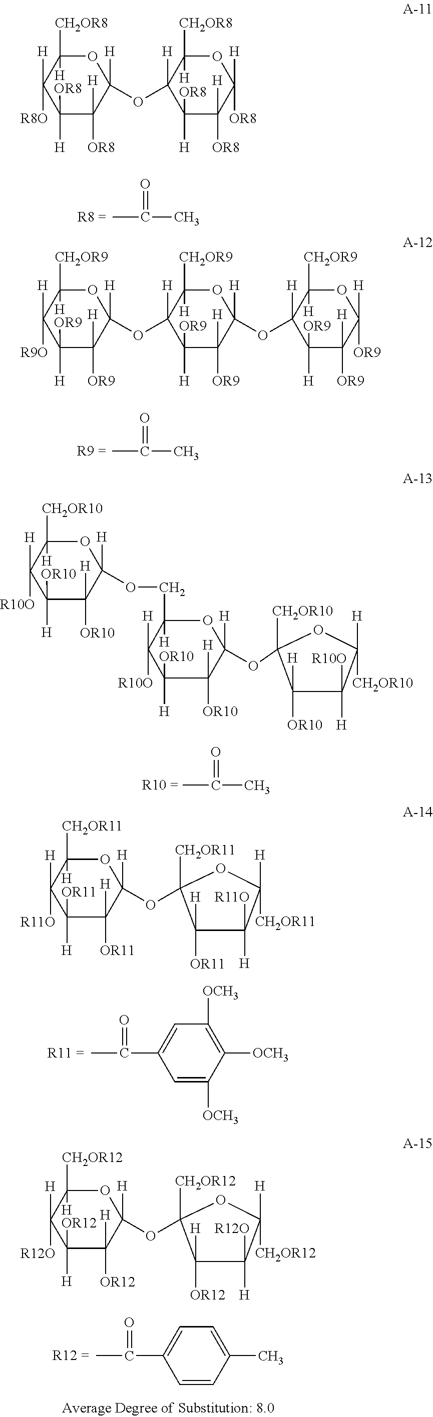

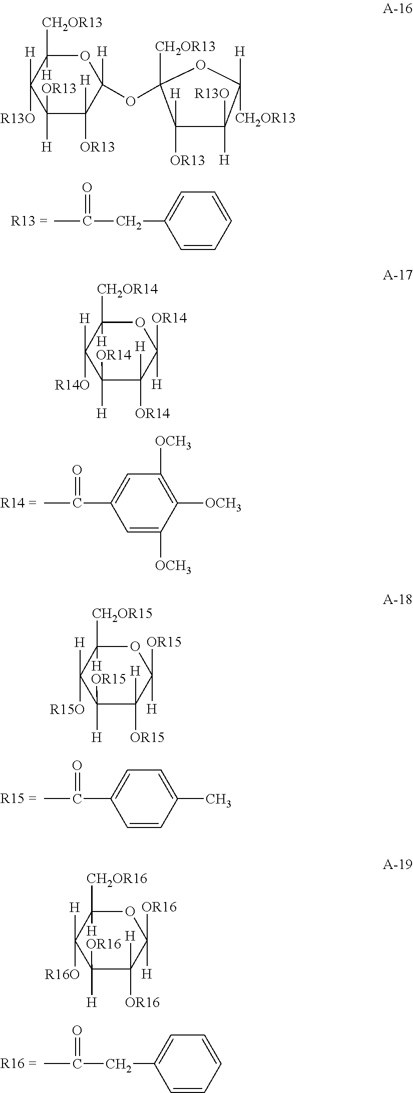

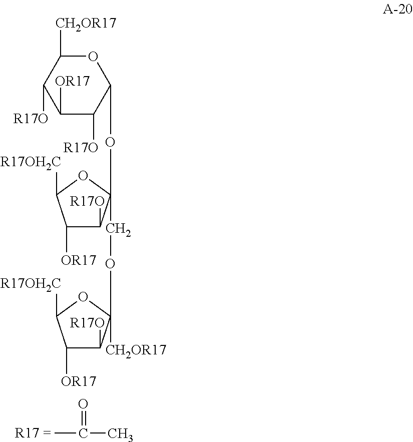

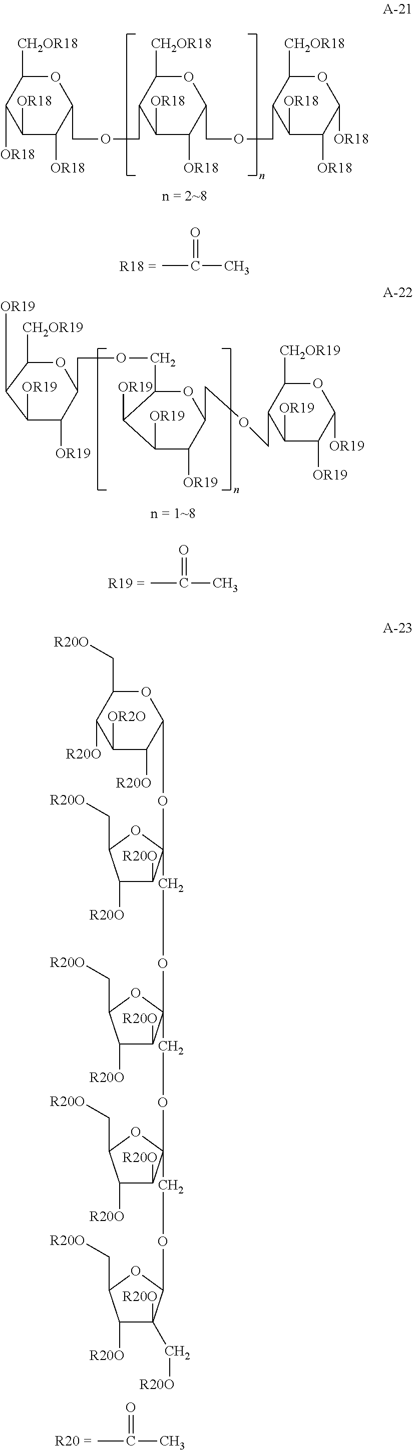

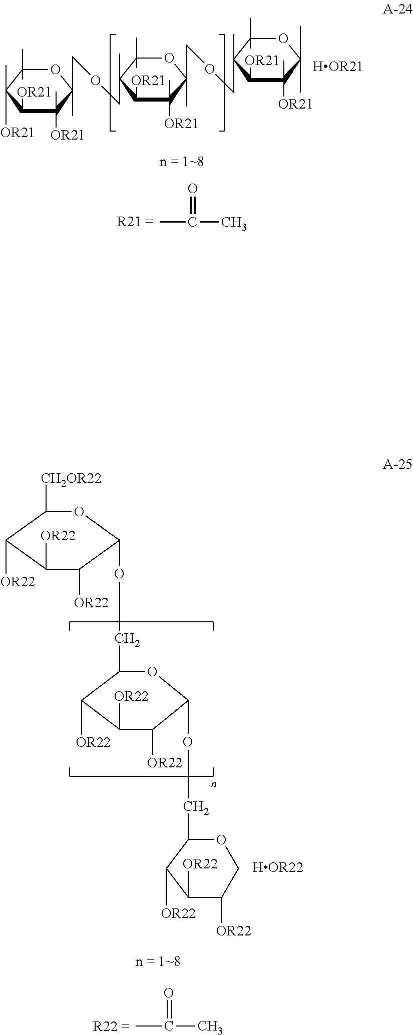

The cellulose ester film of the present invention contains preferably the sugar ester compound in the amount of less than 15% by mass, and more preferably less than 10% by mass, based on the cellulose ester.

As the retardation developer of the present invention, a polymer-based additive as well as the low molecular weight compound may be used. In the present invention, the polyester may also work as the retardation developer.

In the present invention, optionally, a degradation inhibitor, a UV absorber, a peeling accelerator, a matting agent, a lubricant and the plasticizer described above and the like may be properly employed.

(Additive)

A degradation inhibitor (for example, antioxidant, peroxide decomposing agent, radical inhibitor, metal inactivating agent, acid trapping agent and amine) may be added to the cellulose ester film. The anti-degradation agent is described in Japanese Patent Application Laid-Open Nos. Hei 3-199201, Hei 5-194789, Hei 5-271471 and Hei 6-107854. The adding amount of the anti-degradation agent is preferably 0.01% to 1% by mass and more preferably 0.01% to 0.2% by mass, of the solution (dope) to be prepared from the viewpoint of exhibiting the effects of the present invention and inhibiting the bleed-out of the anti-degradation agent on the surface of the film.

Particularly preferable examples of the anti-degradation agent include butylated hydroxytoluene (BHT) and tribenzylamine (TBA).

An UV absorber may be added to the cellulose ester film of the present invention. As the UV absorber, a compound described in Japanese Patent Application Laid-Open No. 2006-282979 (benzophenone, benzotriazole, and triazine) is preferably used. Two or more UV absorbers may be used in combination.

As the UV absorber, benzotriazole is preferred, and specifically, TINUVIN328, TINUVIN326, TINUVIN329, TINUVIN571, ADEKASTAB LA-31, and the like are exemplified.

The amount of the UV absorber to be added is preferably 10% or less, more preferably 3% or less, and most preferably 0.05% to 2%, by mass based on the cellulose ester.

(Peeling Accelerator)

The film of the present invention may preferably contain a peeling accelerator for further improving a releasing property. For example, the peeling accelerator may be used in an amount of 0.001% by weight to 1% by weight. If the amount thereof is 0.5% by weight or less, it is favorable due to difficulty of separation of the peeling agent from the film, if the amount thereof is 0.005% by weight or more, it is favorable since the release reducing effect can be obtained. Thus, the peeling accelerator is preferably used in the amount of 0.005% by weight to 0.5% by weight, and more preferably 0.01% by weight to 0.3% by weight. The peeling accelerator may be any known peeling accelerator such as organic or inorganic acid compounds, surfactants, chelating agent or the like. Among them, polycarboxylic acids and the esters thereof are effective, and the ethylesters of the citric acid are more effective.

(Matting Agent Fine Particles)

It is preferred that the cellulose ester film of the present invention contains fine particles as a matting agent. Examples of the fine particles used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferred in that the turbidity is reduced, and silicon dioxide is particularly preferred. It is preferred that fine particles of silicon dioxide have an average primary particle diameter of 20 nm or less and an apparent specific gravity of 70 g/L or more. Those having a small average particle diameter of primary particles as from 5 nm to 16 mu are more preferred because the haze of the film may be reduced. The apparent specific gravity is preferably 90 g/L to 200 g/L, and more preferably 100 g/L to 200 g/L. A larger apparent specific gravity is preferred because a dispersion with a high concentration may be prepared and thus the haze and the agglomerated material are excellent.

Preferred embodiments thereof are described in detail in Japan Institute of Invention and Innovation Journal of Technical Disclosure (Technical Publication No. 2001-1745, Mar. 15, 2001, published by Japan Institute of Invention and Innovation) pp. 35 to 36, and may be preferably used even in the cellulose ester film of the present invention.

<Method for Manufacturing Cellulose Ester Film>

The cellulose ester film of the present invention can be manufactured by any known method for producing a cellulose ester film, and preferably by a solvent casting method.

For example, in the solvent casting method, the cellulose acylate film may be manufactured using a solution (dope) in which a cellulose acylate is dissolved in an organic solvent. Hereinafter, the method for manufacturing the film, for example a cellulose acylate film, will be described.

The organic solvents are preferably selected from ethers having 3 to 12 carbon atoms, ketones having 3 to 12 carbon atoms, esters having 3 to 12 carbon atoms and halogenated hydrocarbons having 1 to 6 carbon atoms. The ethers, the ketones and the esters may have a cyclic structure. Compounds having two or more functional groups of ethers, ketones and esters (i.e., —O—, —CO— and —COO—) are also usable herein as the organic solvent. The organic solvents may have any other functional group such as an alcoholic hydroxyl group. In tease of an organic solvent having two or more kinds of functional groups, the number of carbon atoms may fall within a defined range of a compound having any one of functional groups.

Examples of the ethers having 3 to 12 carbon atoms include diisopropyl ether, dimethoxymethane, dimethoxyethane, 1,4-dioxane, 1,3-dioxolane, tetrahydrofuran, anisole and phenetole.

Examples of the ketones having 3 to 12 carbon atoms include acetone, methyl ethyl ketone, diethyl ketone, diisobutyl ketone, cyclohexanone and methylcyclohexanone.

Examples of the esters having 3 to 12 carbon atoms include ethyl formate, propyl formate, pentyl formate, methyl acetate, ethyl acetate and pentyl acetate.

Examples of the organic solvents having two or more functional groups include 2-ethoxyethyl acetate, 2-methoxyethanol and 2-butoxyethanol.

The number of carbon atoms in the halogenated hydrocarbon is preferably 1 or 2, and most preferably 1. The halogen in the halogenated hydrocarbon is preferably chlorine. The ratio of hydrogen atoms in the halogenated hydrocarbon to be substituted by halogens is preferably 25 mol % to 75 mol %, more preferably 30 mol % to 70 mol %, even more preferably 35 mol % to 65 mol %, and most preferably 40 mol % to 60 mol %. Methylene chloride is a representative halogenated hydrocarbon.

The organic solvent may be used in a mixture of two or more kinds thereof.

The cellulose acylate solution (dope) may be prepared according to an ordinary method. The ordinary method means that the solution is processed at a temperature not lower than 0° C. (room temperature or high temperature). For preparing the solution, a method and an apparatus for dope preparation according to an ordinary solvent casting method may be employed. In the ordinary method, a halogenated hydrocarbon (especially, methylene chloride) as the organic solvent is preferably used.

The amount of cellulose acylate is adjusted such that cellulose acylate is included in an amount of 10% by mass to 40% by mass based on the amount of a solution to be obtained. The amount of cellulose acylate is more preferably 10% by mass to 30% by mass. Any additives may be added in the organic solvent (main solvent).

The solution can be prepared by stirring the cellulose acylate and the organic solvent at a room temperature (from 0° C. to 40° C.). The high-concentration solution may be stirred under pressure and heating conditions. Specifically, the cellulose acylate and the organic solvent are put in a pressure vessel and hermetically sealed, and followed by stirring under pressure while heating at a temperature of the boiling point or higher of the solvent at room temperature, or at a temperature within a range where the solvent is not boiled. The heating temperature is usually 40° C. or higher, preferably from 60° C. to 200° C., and more preferably from 80° C. to 110° C.

Each component may be coarsely mixed in advance, and then put into the vessel. The components may be successively charged into the vessel. It is necessary that the vessel is configured such that stirring can be achieved. The vessel can be pressurized by injecting an inert gas such as a nitrogen gas. A rise in the vapor pressure of the solvent due to heating may be utilized. Alternatively, each component may be added under pressure after hermetically sealing the vessel.

In the case of heating, it is preferable that heating is carried out from the outside of the vessel. For example, a jacket type heating device can be used. The whole vessel can be heated by installing a plate heater in the outside of the vessel and laying a pipe to circulate a liquid therein.

It is preferred to provide a stirring blade in the vessel to carry out a stirring operation using the stirring blade. The stirring blade has preferably a length so as to reach the vicinity of a wall of the vessel. It is preferable that a scraping blade is provided at the terminal of the stirring blade for the purpose of renewing a liquid film of the wall of the vessel.

Measuring instruments such as a pressure gauge, a thermometer, and the like may be installed in the vessel. In the vessel, each component is dissolved in a solvent. The prepared dope is cooled and then taken out from the vessel, or taken out from the vessel and then cooled by using a heat exchanger or the like.

The solution may also be prepared according to a cooling dissolution method. According to the cooling dissolution method, the cellulose acylate may be dissolved even in an organic solvent in which it can be hardly dissolved in an ordinary dissolution method. Even in the solvent in which the cellulose acylate can be dissolved in an ordinary dissolution method, the cooling dissolution method is advantageous in that a uniform solution can be prepared rapidly.

In the cooling dissolution method, first, the cellulose acylate is gradually added to an organic solvent at room temperature while stirring. The amount of the cellulose acylate is so controlled that the resulting mixture can contain the cellulose acylate in an amount of from 10% by mass to 40% by mass. The amount of the cellulose acylate is more preferably from 10% by mass to 30% by mass. Further, any additives to be mentioned below may be added to the mixture.

Next, the mixture is cooled to −100° C. to −10° C. (preferably −80° C. to −10° C., more preferably −50° C. to −20° C., most preferably −50° C. to −30° C.). The cooling may be attained, for example, in a dry ice/methanol bath (−75° C.) or in a cooled diethylene glycol solution (−30° C. to −20° C.). Thus cooled, the mixture of the cellulose acylate and the organic solvent is solidified.

The cooling speed is preferably at least 4° C./min, more preferably at least 8° C./min, most preferably at least 12° C./min. The higher cooling speed is more preferable, but its theoretical uppermost limit is 10,000° C./sec, the technical uppermost limit is 1,000° C./sec, and the practicable uppermost limit is 100° C./sec. The cooling speed is a value computed by dividing the difference between the temperature at the start of the cooling and the final cooling temperature by the time taken from the start of the cooling to the arrival to the final cooling temperature.

Further, when it is heated at 0° C. to 200° C. (preferably 0° C. to 150° C., more preferably 0° C. to 120° C., most preferably 0° C. to 50° C.), and the cellulose acylate is thereby dissolved in the organic solvent. For the heating, the mixture may be left at room temperature, or may be heated in a hot bath. The heating speed is preferably at least 4° C./min, more preferably at least 8° C./min, most preferably at least 12° C./min. The higher heating speed is more preferable; but its theoretical uppermost limit is 10,000° C./sec, the technical uppermost limit is 1,000° C./sec, and the practicable uppermost limit is 100° C./sec. The heating speed is a value computed by dividing the difference between the temperature at the start of the heating and the final heating temperature by the time taken from the start of the heating to the arrival to the final heating temperature.

As in the above, a uniform solution can be obtained. When the dissolution is insufficient, then the cooling and heating operation may be repeated. Whether or not the dissolution is satisfactory may be determined merely by visually observing the outward appearance of the solution.

In the cooling dissolution method, for the purpose of preventing the mixture from being contaminated with water from the dew formed in cooling, a sealed vessel is preferably used. In the cooling and heating operation, preferably, the vessel is made under pressure in cooling and is made under reduced pressure in heating, thereby shortening the dissolution time. For pressurizing and depressurizing the vessel, a pressure resistant vessel is preferably used.

A 20% by mass solution prepared by dissolving the cellulose acylate (having a degree of total acetyl substitution of 60.9%, and having a viscosity-average degree of polymerization of 299) in methyl acetate according to the cooling dissolution method has a pseudo-phase transition point between a sol state and a gel state at around 33° C., when analyzed through differential scanning calorimetry (DSC), and at a temperature equal to or lower than the point, the solution becomes in the form of a uniform gel. Accordingly, the solution needs to be stored at a temperature not lower than the pseudo-phase transition temperature, preferably at around a temperature of the gel-phase transition temperature plus 10° C. However, the pseudo-phase transition temperature differs, depending on the degree of total acetyl substitution and the viscosity-average degree of polymerization of the cellulose acylate and on the solution concentration and the organic solvent used.

The cellulose acylate film can be manufactured from the prepared cellulose acylate solution (dope) by a solvent casting method.

The dope is cast on a drum or a band, and the solvent is vaporized to form a film. It is preferable that the dope before casting is adjusted so as to have a concentration in the range of 18% by mass to 35% by mass in terms of solids content. It is preferable that the surface of the drum or band is mirror-finished. The casting and drying method in the solvent casting method is described in U.S. Pat. Nos. 2,336,310, 2,367,603, 2,492,078, 2,492,977, 2,492,978, 2,607,704, 2,739,069 and 2,739,070, British Patent Nos. 640,731 and 736,892, and in Japanese Patent Publication Nos. S45-4554 and S49-5614, and Japanese Patent Application Laid-Open Nos. S60-176834, S60-203430 and S62-115035.

Preferably, the dope is cast on a drum or a band at a surface temperature of 10° C. or lower. After thus cast, preferably, the dope is dried by exposing to the wind for at least 2 seconds. The formed film is peeled away from the drum or the band, and then it may be dried with the high-temperature wind of which the temperature is stepwise changed from 100° C. to 160° C. to thereby remove the residual solvent by vaporization. This method is described in Japanese Patent Publication No. H05-17844. According to the method, the time to be taken from the casting to the peeling may be shortened. In order to carry out the method, the dope needs to be gelled at the surface temperature of the drum or the band on which it is cast.

For improving the mechanical physical properties of the cellulose ester film or for increasing the drying speed thereof, a plasticizer may be added to the cellulose ester film. As the plasticizer, phosphate esters or carboxylate esters may be used. Examples of the phosphate esters include triphenyl phosphate (TPP) and tricredyl phosphate (TCP). Examples of the carboxylate esters typically include a phthalate ester and a citrate ester. Examples of the phthalate ester include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrate ester include triethyl O-acetylcitrate (OACTE) and tributyl O-acetylcitrate (OACTB). Other examples of carboxylate esters include butyl oleate, methylacetyl ricinoleate, dibutyl sebacate, and various trimellitate esters. Preferred for use herein are phthalate ester-based plasticizers (DMP, DEP, DBP, DOP, DPP, and DEHP). More preferred are DEP and DPP. The amount of the plasticizer to be added is preferably 0.1% by mass to 25% by mass, more preferably 1% by mass to 20% by mass, and most preferably 3% by mass to 15% by mass, based on the amount of the cellulose acylate.

(Co-Casting)

The cellulose acylate solution obtained in the present invention may be cast as a single-layer solution on a smooth band or drum as a metal support, and a plurality of cellulose acylate solutions for two layers or more may be cast. When the plurality of cellulose acylate solutions are cast, the film may be manufactured by casting each of solutions including cellulose acylate from a plurality of casting nozzles prepared at intervals in the progressing direction of a metal support and then stacking cellulose acylate solutions. Methods described in Japanese Patent Application Laid-Open Nos. S61-158414, H01-122419 and H11-198285, can be adopted. A cellulose acylate solution from two casting nozzles may be cast to form a film, and for example, the casting may be performed by methods described in Japanese Patent Publication No. S60-27562, and Japanese Patent Application Laid-Open Nos. S61-94724, S61-947245, S61-104813, S61-158413 and H06-134933. A cellulose acylate film casting method described in Japanese Patent Application Laid-Open No. S56-162617 may be used, which includes: covering the stream of a high-viscosity cellulose acylate solution with a low-viscosity cellulose acylate solution; and simultaneously extruding the high/low viscosity cellulose acylate solutions. It is also one of preferred aspects that an external solution contains alcoholic components as poor solvents in larger amounts than an internal solution, as described in Japanese Patent Application Laid-Open Nos. S61-94724 and S61-94725.

A film may be manufactured by using two casting nozzles to peel off a film formed on a metal support by a first casting nozzle and subjecting the side of the film coming into contact with the surface of the metal support to second casting, and for example the method described in Japanese Patent Publication No. S44-20235 may be used. The cellulose acylate solutions to be cast may be the same as or different from each other, and are not particularly limited. In order to allow a plurality of cellulose acylate layers to have functions, cellulose acylate solutions corresponding to the respective functions may be extruded from the respective casting nozzle. The cellulose acylate solution of the present invention can be cast simultaneously with another functional layer (for example, an adhesion layer, a dye layer, an antistatic layer, an anti-halation layer, an ultraviolet ray absorbing layer, a polarizing layer, and the like).

In a conventional single-layer solution, in order to manufacture a film with a desired thickness, it is necessary to extrude a high-viscosity cellulose acylate solution at a high concentration. As a solution to this, by casting a plurality of cellulose acylate solutions from casting nozzles, high-viscosity solutions can be extruded onto the metal support at the same time, and thus a film having improved planarity and excellent surface state can be manufactured. By using concentrated cellulose acylate solutions, a reduction in drying load can be achieved, and thus the manufacturing speed of the film can be enhanced.

In the case of co-casting, thicknesses of inner and outer sides are not particularly limited. However, the thickness of the outer side is preferably 1% to 50% based on the thickness of the whole film, and more preferably 2% to 30%. Herein, in the case of co-casting of 3 layers or more, the total film thickness of a layer adjacent to the metal support and a layer adjacent to air side is defined as a thickness on the outer side.

In co-casting, cellulose acylate solutions in which the concentration of the additives such as the above-mentioned plasticizer, UV absorbent, matting agent and the like differs may be co-cast to manufacture a cellulose acylate film having a stacking structure. For example, a cellulose acylate film having a constitution of a skin layer/a core layer/a skin layer can be manufactured. For example, the matting agent can be put in a larger amount into the skin layer, or only into the skin layer. The plasticizer and the UV absorbent may be more in the core layer than in the skin layer, or may be only in the core layer. The type of the plasticizer and the UV absorbent may differ between the core layer and the skin layer. For example, a low-volatile plasticizer and/or UV absorbent may be in the skin layer, and a plasticizer of excellent plasticization or a UV absorbent of excellent UV absorption may be added to the core layer. An embodiment of adding a release agent to only the skin layer on the side of the metal support is also preferred. In order to gel the solution by cooling the metal support in a cooling drum method, alcohol as a poor solvent is preferably more in the skin layer than in the core layer. Tg may differ between the skin layer and the core layer. Preferably, Tg of the core layer is lower than that of the skin layer. The viscosity of the cellulose acylate-containing solutions to be cast may differ between the skin layer and the core layer. Preferably, the viscosity of the solution for the skin layer is smaller than that for the core layer, but the viscosity of the solution for the core layer may be smaller than that for the skin layer.

A drying method of a web, which is dried on a drum or belt and peeled off, will be described. The web, which is peeled off at a peeling position immediately before the drum or the belt goes on a round, is conveyed by a conveying method which allows the web to pass alternately through a group of rolls disposed in a zig-zag pattern, or by a conveying method which allows the peeled web to be nipped by means of a clip and the like at both edges thereof and conveyed in a non-contact way. Drying is carried out by blow-drying both sides of the web (film) while being conveyed at a predetermined temperature or by a heating means such as a microwave oven and the like. Rapid drying may damage the planarity of a film to be formed, and thus it is preferred that the film is dried at a temperature where bubbles are not produced from the solvent at the early stage of drying, drying is progressed to some degrees, and then the film is dried at a high temperature. In the drying process after peeling-off from the support, the film is apt to shrink in a length or width direction by evaporation of the solvent. The shrinkage increases as drying is performed at higher temperatures. It is preferred that the planarity of the manufactured film is improved if the film is dried while the shrinkage is being suppressed as much as possible. In this regard, as disclosed, for example, in Japanese Patent Application Laid-Open No. S62-46625, it is preferable to perform the whole or part of the drying process while the both edges of the width of the web is maintained by means of a clip or pin in a width direction (tenter type). In the drying process, the drying temperature is preferably 100° C. to 145° C. The drying temperature, drying air flow and drying time vary depending on the solvent to be used, but may be appropriately selected according to the kind and combination of solvents to be used. In the manufacture of the film of the present invention, it is preferable to stretch the web (film) peeled from the support when the residual solvent amount is less than 120% by mass based on the web.

The residual solvent amount may be represented by the following formula:

Residual Solvent Amount (% by mass)={(M−N)/N}×100

where M means the mass of the web at a point of time, and N means the mass of the web having the mass M, dried at 110° C. for 3 hours. If the residual solvent amount in the web is excessively high, it is impossible to obtain stretching effects, while when the amount is excessively low, it becomes significantly difficult to perform stretching, and thus the web may break. The residual solvent amount in the web is more preferably 70% by mass or less, even more preferably 10% by mass to 50% by mass, and particularly preferably 12% by mass to 35% by mass. When the stretching magnification is excessively low, it is impossible to obtain a sufficient retardation, while when the stretching magnification is excessively high, it becomes significantly difficult to perform stretching, and thus the web may break.

The stretching magnification is preferably 1.1 to 1.5, and more preferably 1.15 to 1.4. Stretching may be performed in a longitudinal or transverse direction, or in both directions, and preferably at least in a longitudinal direction. The Re can be developed more appropriately by keeping the stretching magnification at 10% or more, and thus Boeing can be improved. The haze can be reduced by keeping the stretching magnification at 50% or less.

In the present invention, the film produced according to a solution casting method and having a residual solvent amount falling within a specific range can be stretched without being heated at a high temperature. However, the film is preferably stretched while dried, as the processing process may be shortened. However, when the temperature of the web is too high, then the plasticizer may volatilize, and therefore, the temperature range is preferably room temperature (15° C.) to 145° C. A method of biaxially stretching the film in the direction perpendicular to each other is effective for controlling the film refractive indices, Nx, Ny and Nz to fall within the range of the present invention. For example, in a case where the film is stretched in the casting direction, when the shrinkage in the width direction is too large, then the value Nz may increase too much. In this case, the problem may be solved by reducing the width shrinkage of the film or by stretching the film in the width direction. In a case where the film is stretched in the width direction, the film may have a refractive index distribution in the width direction. This often occurs, for example, when a tenter method is employed for film stretching. This is a phenomenon to be caused by the generation of the shrinking force in the center portion of the film while the edges of the film are kept fixed, and this may be considered as so-called a bowing phenomenon. Even in this case, the bowing phenomenon can be prevented by stretching the film in the casting direction, whereby the retardation distribution in the width direction can be reduced. Further, by biaxially stretching the film in the directions perpendicular to each other, the film thickness fluctuation may be reduced. When the film thickness fluctuation of the optical film is too large, then the retardation blur thereof may be formed. The film thickness fluctuation of the optical film is preferably within a range of ±3%, more preferably within a range of ±1%. For the above-mentioned objects, the method of biaxially stretching the film in the directions perpendicular to each other is effective, and the biaxially stretching magnification in the directions perpendicular to each other is preferably 1.2 to 2.0 times and 0.7 to 1.0 times, respectively. The mode of stretching the film by 1.2 to 2.0 times in one direction and by 0.7 to 1.0 times in the other direction perpendicular to the one direction means that the interval between the clips or the pins supporting the film is made to be 0.7 to 1.0 times the interval therebetween before the stretching.

In general, in a case where the film is stretched in the width direction by 1.2 to 2.0 times, using a biaxial stretching tenter, a shrinking force acts on the perpendicular direction thereof, that is, on the longitudinal direction of the film.

Accordingly, when the film is continuously stretched while applying a force only in one direction, the width of the film in the other direction perpendicular to the one direction may shrink. This means that the shrinking degree is suppressed without controlling the width of the film, and the interval between the clips or the pins for width control is defined to be 0.7 to 1.0 times over the interval therebetween before stretching. In this case, a force of shrinking the film in the longitudinal direction acts on the film due to the stretching in the width direction. The interval kept between the clips or the pins in the longitudinal direction makes it possible to prevent any unnecessary tension from being applied to the film in the longitudinal direction thereof. The method of stretching the web is not specifically limited. For example, the method may be a method of providing plural rolls each running at a different peripheral speed and stretching the film in the longitudinal direction based on the peripheral speed difference between the rolls, a method of holding both sides of the web with clips or pins and expanding the interval between the clips or pins in the progressing direction to thereby stretch the film in the longitudinal direction, or expanding the interval therebetween in the width direction to thereby stretch the film in the width direction, or a method of expanding the interval both in the longitudinal and width directions to thereby stretch film in both the longitudinal and width directions. Of course, these methods may be combined. In case of so-called the tenter method, preferably, the clip parts are driven according to a linear driving system, by which the film may be smoothly stretched with little risk of breaking and the like.

A common winding machine may be used to wind films thus obtained according to a winding method, such as a constant tension method, a constant torque method, a taper tension method, and a program tension control method of constant internal stress. In an optical film roll thus obtained, the slow axis direction of the film is preferably ±2°, and more preferably ±1° with respect to the winding direction (longitudinal direction of the film). Alternatively, the slow axis direction of the film is preferably ±2°, and more preferably within ±1° with respect to the direction (width direction of the film) perpendicular to the winding direction. In particular, the slow axis direction of the film is preferably within ±0.1° with respect to the winding direction (longitudinal direction of the film). Otherwise, the slow axis direction of the film is preferably within ±0.1° with respect to the width direction of the film.

[Film Thickness]

The thickness of the cellulose ester film may be properly determined according to the use thereof, and the thickness is preferably 30 μm to 100 μm, and more preferably 40 μm to 80 μm. It is preferable to set the thickness of the film to 60 μm or less, thereby reducing the cost.

(Optical Properties)

Wavelength Dispersion:

In the present invention, the cellulose ester film satisfying the wavelength dispersion of the following Equation (1) is preferred.

ΔRe>0 Equation (1)

(wherein, ARe=Re(630)−Re(430); Re(630) represents an in-plane retardation at the wavelength of 630 nm; and Re(430) represents an in-plane retardation at the wavelength of 430 nm)

The cellulose acylate film satisfying the Formula (1) is favorable since color shift can be improved in a panel form.

More preferably, the wavelength dispersion of the cellulose ester film of the present invention may satisfy ΔRe>2.0.

Re and Rth:

In the cellulose ester film of the present invention, the in-plane retardation at the wavelength of 590 nm, Re(590) may be 30 nm<Re(590)<100 nm, and the retardation in a thickness-direction at the wavelength of 590 nm, Rth(590) may be 80 nm<Rth(590)<300 nm.

The Re(590) is preferably 30 nm<Re(590)<100 nm, and more preferably 40 nm<Re(590)<80 nm.

The Rth(590) is preferably 80 nm<Rth(590)<300 nm, and more preferably 80 nm<Rth(590)<150 nm.

Herein, the Re and the Rth are values defined as the following Formula (1) and Formula (II).

Re=(nx−ny)×d (nm) Equation (I)

Rth={(nx+ny)/2−nz}×d (nm) Equation (II)

(wherein nx represents a refractive index in the in-plane slow axis direction of a film, ny represents a refractive index in the in-plane fast axis direction of the film, nz represents a refractive index in the thickness direction of the film, and d represents a film thickness (nm)).

Re(λ) and Rth(λ) represent an in-plane retardation and a retardation in a thickness-direction at a wavelength of λ, respectively. In the present specification, unless otherwise noted, the wavelength of λ is 590 nm. The Re(λ) is measured by irradiating with an incident light of k nm in wavelength in the normal direction of the film using KOBRA 21ADH (manufactured by Oji Scientific Instruments Co., Ltd.). With the in-plane slow axis (determined by KOBRA 21ADH or WR) taken as an inclined axis (rotation axis) of the sample (in a case where the sample has no slow axis, the rotation axis of the sample may be in any in-plane direction of the sample), Re(λ) of the sample is measured at 6 points in all thereof, from the normal direction up to 50° with respect to the normal direction of the sample at intervals of 10°, by applying a light having a wavelength of λ nm from the inclined direction of the sample, and the Rth (λ) may be calculated by KOBRA 21ADH based on the thus-measured retardation values, the estimated value of the average refractive index and the inputted film thickness value. With the slow axis taken as the inclined axis (rotation axis) (in a case where the sample has no slow axis, the rotation axis of the sample may be in any in-plane direction of the film), the retardation values of the sample are measured in any two directions; and based on the data and the estimated average refractive index and the inputted thickness of the sample, Rth may be calculated according to the following Formula (A) and Formula (B). As the estimated average refractive index, values described in a polymer handbook (JOHN WILEY & SONS, INC.) and catalogues of various optical films can be used. For films where the average refractive index is unknown, the average refractive index can be measured by using an Abbe's refractometer. Values of the average refractive index of main optical films are exemplified below: cellulose acylate (1.48), cycloolefin polymer (1.52), polycarbonate (1.59), polymethylmethacrylate (1.49) and polystyrene (1.59). The nx, the ny and the nz are calculated by inputting the assumed values of the average refractive index and the film thickness into KOBRA 21ADH. On the basis of the thus calculated nx, ny and nz, Nz=(nx−nz)/(nx−ny) is further calculated.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Equation ( A )$$

Where Re(θ) represents the retardation value in the direction inclined in the degree of angle (θ) from the normal direction. d represents a film thickness.

Rth=((nx+ny)/2−nz)×d Equation (B) (the above Equation (II))

In this case, the average refractive index n is needed as a parameter, and it is measured with an Abbe's refractometer (“Abbe's refractometer 2-T” manufactured by ATAGO CO., LTD.).

The cellulose ester film is preferably formed by stretching, and the stretching is preferably performed in-line. Optionally, winding may be performed in advance, and then the stretching may be performed in other process. Further, the in-line stretching may be performed in advance, and the wingding may be performed followed by further performing the stretching in other process. By stretching the film in this manner, the film having low haze may be manufactured, and therefore the film having low Re/Rth value may be obtained.

(Internal Haze)

The film of the present invention has preferably an internal haze less than 0.20%, more preferably less than 0.15%, and particularly preferably less than 0.10%. Having the internal haze of less than 0.2%, the contrast ratio may be improved when being applied to a liquid crystal display device. Further, the transparency of the film becomes enough high to be easily used as an optical film.

[Weight Reduction Rate of Film]

Weight reduction rate of the cellulose ester film of the present invention kept at 180° C. for 1 hour is preferably less than 0.4%, more preferably less than 0.3%, and even more preferably less than 0.2%. If the weight reduction rate thereof is less than 0.4%, it means that the volatilization of the additive such as polyester from the cellulose ester film is suppressed, and the generation of optical or mechanical performance change (for example, deterioration of film surface) may be prevented.

The weight reduction rate of the film can be measured by TG-DTA (Thermogravimetry-Differential Thermal Analysis) and calculated by the following Formula.

Weight reduction rate(%)=(amount of weight change at 180° C. for 1 hour/initial film weight)×100

As described above, in the present invention, the weight reduction rate of the film may be lowered to 0.4% or less by adding the polyester in which the low molecular weight component is removed (rate of the component having molecular weight of 500 or less is less than 8%).

(Functional Layer)

The cellulose ester film of the present invention is applied to, for example, an optical use and a photographic photosensitive material as the uses thereof. In particular for the optical use, it is preferred that the film is used as a protective film of a polarizing plate and thus the polarizing plate is used in a liquid crystal display device. The liquid crystal display devices are preferably of TN, IPS, FLC, AFLC, OCB, STN, ECB, VA and HAN.

In this case, imparting of various functional layers is carried out on the cellulose ester film of the present invention. Examples thereof include an antistatic layer, a curable resin layer (transparent hard coat layer), an antireflection layer, an easy-to-adhere layer, an antiglare layer, an optically-compensatory layer, an alignment layer, a liquid crystal layer, and the like. The functional layers and materials thereof may include a surfactant, a slipping agent, a matting agent, an antistatic layer, a hard coat layer, and the like, and are described in details in Japan Institute of Invention and Innovation Journal of Technical Disclosure (Technical Publication No. 2001-1745, Mar. 15, 2001, published by Japan Institute of Invention and Innovation) pp. 32 to 45, which may be preferably used in the invention.

<<Retardation Film>>

The cellulose ester film of the present invention may be used as a retardation film.

The “retardation film” is generally used in display devices such as liquid crystal display device, and the like, means an optical material having optical anisotropicity, and is synonymous with a retardation plate, an optically compensatory film, an optically compensatory sheet, and the like. In the liquid crystal display device, the retardation film is used for the purpose of enhancing the contrast of a display screen or improving viewing angle characteristics or tint.

Retardation may be freely controlled by using the cellulose ester film of the present invention, and thus a retardation film having excellent adhesion with a polarizer may be manufactured.

The cellulose ester film of the present invention may be used as a retardation film by stacking a plurality of optical films of the present invention or stacking the optical film of the present invention with a film out of the present invention to control Re or Rth appropriately. The stacking of films may be performed by using an adhesive or an adhesion bond.

In some cases, the cellulose ester film of the present invention may be used as a support of a retardation film, and then, by providing an optically anisotropic layer including a liquid crystal and the like thereon, a retardation film is formed. The optically anisotropic layer applied to the retardation film may be formed as, for example, a composition containing a liquid crystalline compound, a polymer film having birefringence, and the optical film of the present invention. In this case, when the manufacturing method of the present invention is performed as a subsequent process of an optically anisotropic layer forming process, it is preferred to bring an organic solvent in contact with a surface opposite to the surface on which the optically anisotropic layer is formed.

As the liquid crystalline compound, discotic liquid crystalline compounds or rod-like liquid crystalline compounds are preferred.

(Discotic Liquid Crystalline Compounds)

Examples of discotic liquid crystal compounds that may be used as the liquid crystalline compounds include compounds described in various documents (for example, C. Destrade et al., Mol. Crysr. Liq. Cryst., vol. 71, page. 111 (1981); edited by the Chemical Society of Japan, Quarterly Issue Chemistry Review Paper, No. 22, Chemistry of Liquid Crystal, Ch. 5, Ch. 10, Sec. 2 (1994); B. Kohne et al., Angew. Chem. Soc. Chem. Comm., page 1794 (1985); and J. Zhang et al., J. Am. Chem. Soc., vol. 116, page 2655 (1994)).

In the optically anisotropic layer, the discotic liquid crystalline molecules are preferably fixed in an aligned state, and are most preferably fixed by a polymerization reaction. The polymerization of discotic liquid crystalline molecules is described in Japanese Patent Application Laid-Open No. Hei 8-27284. In order to fix the discotic liquid crystalline molecules by polymerization, it is necessary to bind a polymerizable group to the discotic core of the discotic liquid crystalline molecules as a substituent. However, when the polymerizable group is directly bound to the discotic core, it becomes difficult to maintain the orientation state for the polymerization reaction. Thus, a linking group is introduced between the discotic core and the polymerizable group. The discotic liquid crystal molecules having a polymerizable group are described in Japanese Patent Application Laid-Open No. 2001-4387.

(Rod-Like Liquid Crystalline Compounds)

Examples of rod-like liquid crystalline compounds that may be used as the liquid crystalline compounds include azomethines, azoxy compounds, cyanobiphenyls, cyanophenyl esters, benzoic esters, phenyl esters of cyclohexanecarboxylic acid, cyanophenylcyclohexanes, cyano-substituted phenylpyrimidines, alkoxy-substituted phenylpyrimidines, phenyldioxanes, tolans and alkenylcyclohexylbenzonitriles. As the rod-like liquid crystalline compounds, not only low molecular liquid crystalline compounds, but also high molecular liquid crystalline compounds may be useful.

In the optically anisotropic layer, the discotic liquid crystalline molecules are preferably fixed in an aligned state, and are most preferably fixed by a polymerization reaction. Examples of polymerizable rod-like liquid crystalline compounds that may be used in the present invention include compounds described, for example, in Makromol. Chem., vol. 190, page 2255 (1989), Advanced Materials, vol. 5, page 107 (1993), U.S. Pat. Nos. 4,683,327, 5,622,648, and 5,770,107, International Publication Nos. WO95/22586, WO95/24455, WO97/00600, WO98/23580, and WO98/52905, and Japanese Patent Application Laid-Open Nos. Hei 1-272551, Hei 6-16616, Hei 7-110469, Hei 11-80081, 2001-328973, and the like.

<<Polarizing Plate>>

The polarizing plate of the present invention includes at least one cellulose ester film of the present invention.

The cellulose ester film of the present invention may be used as a protective film of the polarizing plate (the polarizing plate of the invention). The polarizing plate of the present invention includes a polarizer and two polarizing plate protective films (optical films) that protect both sides thereof, and the cellulose ester film of the present invention is particularly preferably used as a polarizing plate protective film on at least one side.

When the cellulose ester film of the present invention is used as the polarizing plate protective film, the cellulose ester film of the present invention is preferably subjected to a surface treatment for hydrophilization, such as the above described surface treatments (also described in Japanese Patent Application Laid-Open Nos. Hei 6-94915 and Hei 6-118232), and for example, a glow discharge treatment, a corona discharge treatment, an alkali saponification treatment, and the like are preferably performed. As the surface treatment, an alkali saponification treatment is used most preferably.

The polarizer may be prepared by, for example, immersing a polyvinyl alcohol film in an iodine solution and stretching the film. When the polarizer prepared by immersing a polyvinyl alcohol film in an iodine solution and stretching the film is used, the optical film of the invention can be attached on its surface treated side directly to both sides of the polarizer with an adhesion bond applied therebetween. In the preparation method of the present invention, it is preferred that the optical film be directly attached to the polarizer in that way. Examples of the adhesion bonds include aqueous solutions of polyvinyl alcohol or polyvinyl acetal (for example, polyvinyl butyral) or latexes of vinyl polymers (for example, polybutyl acrylate). An aqueous solution of completely saponified polyvinyl alcohol is a particularly preferred adhesion bond.

A liquid crystal display device generally has a liquid crystal cell disposed between a pair of polarizing plates and therefore contains four polarizing plate protective films. While the optical film of the present invention may be used as any one or more of the four polarizing plate protective films, it is particularly advantageous to use the optical film of the present invention as the protective film disposed between the polarizer and the liquid crystal layer (liquid crystal cell) in a liquid crystal display device. A transparent hardcoat layer, an antiglare layer, an antireflective layer, and the like may be provided on the protective film disposed on the side opposite to the side of the optical film of the present invention between the polarizers and is particularly preferably used as the polarizing plate protective film of the outermost surface of the display side of a liquid crystal display device.

The polarizing plate is composed of a polarizer and a protective film that protects both sides thereof and combines and is further composed of a protective film on one side of the polarizing plate and a separate film on the other side thereof. Both the protective film and the separate film are used for the purpose of protecting the polarizing plate during shipment of the polarizing plate or inspection of the product. In this case, the protective film is attached for the purpose of protecting the surface of the polarizing plate, and the polarizing plate is used on the side opposite to the surface in contact with the liquid crystal plate. The separate film is used for the purpose of covering the adhesion bond layer which is attached to the liquid crystal plate, and used on the side which attaches the polarizing plate to the liquid crystal plate.

In the liquid crystal display device, a substrate including a liquid crystal is usually disposed between two polarizing plates, but the polarizing plate protective film to which the optical film of the present invention is applied may provide excellent display qualities even though the protective film may be disposed in any portion. In particular, a transparent hardcoat layer, an antiglare layer, an antireflective layer, and the like are provided on the protective film on the outermost surface on the display side of a liquid crystal display device, and thus the polarizing plate protective film is particularly preferably used on this portion.

<<Liquid Crystal Display Device>>

The cellulose ester film and polarizing plate of the present invention may be used for liquid crystal display devices of various display modes. Hereinafter, each of the liquid crystal modes in which these films may be used will be described. Among these modes, the cellulose ester film and polarizing plate of the present invention may be preferably used in all the modes, but are particularly preferably used for liquid crystal display devices of VA mode and IPS mode, and are most preferably used for liquid crystal display devices of VA mode. These liquid crystal display devices may be any one of a transmissive type, a reflective type, and a semi-transmissive type.

(TN Type Liquid Crystal Display Device)

The cellulose ester film of the present invention is preferably used as a support of a retardation film in a TN type liquid crystal display device having a TN mode liquid crystal cell. TN mode liquid crystal cells and TN type liquid crystal display devices have long been known. The retardation film used in TN type liquid crystal display devices is described in Japanese Patent Application Laid-Open Nos. Hei 3-9325, Hei 6-148429, Hei 8-50206, and Hei 9-26572, and Mori et al., papers (Jpn. J. Appl. Phys., vol. 36 (1997), p. 143 or Jpn. J. Appl. Phys. Vol. 36 (1997), p. 1068).

(STN Type Liquid Crystal Display Device)

The cellulose ester film of the present invention may be used as a support of a retardation film in an STN type liquid crystal display device having an STN mode liquid crystal cell. In common STN type liquid crystal display devices, rod-like liquid crystal molecules in the liquid crystal cell are twisted in the range of 90° to 360°, and the product (And) of the refractive index anisotropy (Δn) of the rod-like crystal molecules and the cell gap (d) are in the range of 300 nm to 1500 nm. The retardation film used in STN type liquid crystal display devices is described in Japanese Patent Application Laid-Open No. 2000-105316.

(VA Type Liquid Crystal Display Device)

The cellulose ester film of the present invention is particularly advantageously used as a retardation film or a support of the retardation film in a VA type liquid crystal display device having a VA mode liquid crystal cell. The VA type liquid crystal display device may have an alignment division mode as described, for example, in Japanese Patent Application Laid-Open No. Hei 10-123576. In these aspects, a polarizing plate using the cellulose ester film of the present invention contributes to the enlargement of viewing angle and the improvement of contrast.

(IPS Type Liquid Crystal Display Device and ECB Type Liquid Crystal Display Device)

The cellulose ester film of the present invention is particularly advantageously used as a retardation film, a support of the retardation film, or a protective film of a polarizing plate in an IPS type liquid crystal display device having an IPS mode liquid crystal cell and an ECB type liquid crystal display device having an ECB mode liquid crystal cell. When black is displayed, these modes are an aspect in which the liquid crystal materials are aligned substantially in parallel with each other, and the liquid crystal molecules are aligned in parallel with the surface of the substrate in no voltage applied state to achieve a black display. In these aspects, a polarizing plate using the cellulose ester film of the present invention contributes to the enlargement of viewing angle and the improvement of contrast.

It is preferred to have |Rth| of less than 25 nm, but it is particularly preferred that the optical film has Rth of 0 nm or less in a region of 450 nm to 650 nm, because tint changes are small.

In these aspects, it is preferred that among protective films of the polarizing plate on and below the liquid crystal cell, the polarizing plate using the cellulose ester film of the present invention is used on and below the liquid crystal cell in a protective film (a protective film on the cell side) disposed between the liquid cell and the polarizing plate. It is more preferred that an optically anisotropic layer set to have a retardation value twice or less the value of Δn·d of the liquid crystal layer is disposed on one side between the protective film of the polarizing plate and the liquid crystal cell.

(OCB Type Liquid Crystal Display Device and HAN Type Liquid Crystal Display Device)

The cellulose ester film of the present invention is also advantageously used as a support of a retardation film in an OCB type liquid crystal display device having an OCB mode liquid crystal cell or an HAN type liquid crystal display device having an HAN mode liquid crystal cell. In the retardation film used in the OCB type or the HAN type liquid crystal display devices, it is preferred that the direction in which the absolute retardation value is the lowest exists in neither an in-plane direction nor the nominal direction thereof. The optical properties of the retardation film used in the OCB type liquid crystal display device or the HAN type liquid crystal display device are also determined by optical properties of the optically anisotropic layer, optical properties of the support, and the arrangement between the optically anisotropic layer and the support. A retardation film used in the OCB type liquid crystal display device or the HAN type liquid crystal display device is described in Japanese Patent Application Laid-Open No. Hei 9-197397. There is also a description in a paper (Mori, et al., Japanese Journal of Appl. Phys., vol. 38 (1999) p. 2837).

<<Reflective Type Liquid Crystal Display Device>>

The cellulose ester film of the present invention is also advantageously used as a retardation film in reflective type liquid crystal display devices of a TN type, an STN type, a HAN type, and a GH (Guest-Host) type. These display modes have long been known. The TN type reflective liquid crystal display devices are described in Japanese Patent Application Laid-Open No. Hei 10-123478, International Publication No. WO98/48320, and Japanese Patent No. 3022477. A retardation film used in the reflective type liquid crystal display device is described in International Publication No. WO00/65384.

(Other Liquid Crystal Display Devices)

The cellulose ester film of the present invention is also advantageously used as a support of a retardation film in axially symmetric aligned microcell (ASM) type liquid crystal display devices having an ASM mode liquid crystal cell. An ASM mode liquid crystal cell is characterized in that the cell thickness is maintained by a resin spacer whose position is adjustable. Other properties are the same as those of a TN mode liquid crystal cell. With respect to the ASM mode liquid crystal cell and the ASM type liquid crystal display device, there is a description in a paper by Kume et al. (SID 98 Digest, p. 1089 (1998)).

The cellulose ester film of the present invention may be used as a retardation film or a support of the retardation film which is preferably used as an image display panel which may display 3D image displays. Specifically, a λ/4 layer may be formed on the entire surface of the cellulose ester film of the present invention or, for example, a patterned retardation layer having different birefringence refractive index alternately in a line type may be formed. The cellulose ester film of the present invention has a smaller dimensional change to a change in humidity than that of the cellulose acylate film in the related art, and thus the optical film may be preferably used over the latter.

(Hardcoat Film, Antiglare Film and Antireflective Film)

The cellulose ester film of the present invention is applicable to a hardcoat film, an antiglare film or an antireflective film. Any one or all of a hardcoat layer, an antiglare layer, and an antireflective layer may be provided on one side or both sides of the optical film of the present invention for the purpose of improving visibility of flat panel displays, such as LCDs, PDPs, CRTs, ELs, and the like. Preferred embodiments of such applications as an antiglare film and an antireflective film are described in detail in Japan Institute of Invention and Innovation Journal of Technical Disclosure (Technical Publication No. 2001-1745, Mar. 15, 2001, published by Japan Institute of Invention and Innovation) pp 54 to 57, and the cellulose ester film of the present invention may be preferably used.

(Transparent Substrate)

Because the cellulose ester film of the present invention may be formed with an optical anisotropy close to zero, has excellent transparency and experiences a small change in retardation even though the film is maintained under a moist heat environment, the cellulose ester film may also be used as a substitute for a liquid crystal cell glass substrate of a liquid crystal display device, that is, a transparent substrate for sealing a driving liquid crystal.

The transparent substrate for sealing a liquid crystal is required to have excellent gas barrier properties, and thus a gas barrier layer may be provided on the surface of the cellulose ester film of the present invention if necessary. The form or material of the gas barrier layer is not particularly limited, but methods of vapor depositing SiO₂ or the like on at least one side of the optical film of the present invention, or providing a coat layer of a polymer having relatively high gas barrier properties, such as vinylidene chloride-based polymer or vinyl alcohol-based polymer, or stacking these inorganic and organic layers are contemplated, and the methods may be appropriately used.

For use as a transparent substrate for sealing a liquid crystal, a transparent electrode for driving a liquid crystal by application of a voltage may be provided. The transparent electrode is not particularly limited, but a transparent electrode may be provided by stacking a metal film, a metal oxide film, and the like on at least one side of the optical film of the present invention. Among them, from the viewpoint of transparency, electrical conductivity, and mechanical properties, metal oxide films are preferred, and among the metal oxide films, a thin film of indium oxide containing mainly tin oxide and zinc oxide in an amount of 2% to 15% may be preferably used. The details of these technologies are disclosed, for example, in Japanese Patent Application Laid-Open Nos. 2001-125079, 2000-227603, and the like.

### EXAMPLES

Hereinafter, characteristics of the present invention will be described in more detail with reference to Examples. The materials, amounts, ratios, operations, order of operations, and the like shown in the Examples below may appropriately be modified without departing from the spirit of the present invention. Therefore, the scope of the present invention should not be construed as being limited by specific Examples shown below.

<<Measurement Methods>>

First, measurement methods and evaluation methods of characteristics are shown below.

[Degree of Substitution]

The degree of substitution of acyl of a cellulose acylate was obtained by ¹³C-NMR analysis in accordance with the methods described in Tezuka et al., Carbohydr. Res., 273 (1995), pp. 83 to 91.

(Optical Properties)

The Re and the Rth were measured at the wavelength of 590 nm with KOBRA 21ADH (manufactured by Oji Scientific Instruments) according to the method described above.

The Re was measured at the wavelengths of 440 nm and 630 nm, respectively, according to the same method, and as the wavelength dispersion ARe, Re(630)−Re(440) was calculated from the values thus obtained.

<Internal Haze of Film>

Measurement of haze may be conducted with a sample having 40 mm×80 mm at 25° C. and 60% RH in accordance with JIS K-6714 by using a haze meter (HGM-2DP, manufactured by Suga Test Instruments Co., Ltd.), after liquid paraffin is applied to the both sides of the film to interpose the film between glass sheets. A blank sample of liquid paraffin and a glass sheet alone with no film sandwiched therebetween was measured in the same manner. The results thus obtained are listed in the following Table.

[Weight Reduction Rate]

Weight reduction rate was calculated from the weight change using TG-DTA6200 (manufactured by SII), after heating the film at 180° C. for 1 hour.

Weight reduction rate (%)=(amount of weight change at 180° C. for 1 hour/initial film weight)×100

[Forced Film Bleed-Out]

The film sample was left under raw material fluctuation condition of a manufacturing machine (under a forced condition, where water (0.3% by mass) was forcedly added to the cellulose acylate solution (dope) described below), and it was checked whether the bleed-out occurred in the manufactured film. The bleed-out on the A4 size was evaluated according to the following four steps.

A: No bleed-out

B: Bleed-out partly

C: Bleed-out slightly on the entire surface

D: Bleed-out on the entire surface

<<1>> Manufacture and Evaluation of Cellulose Ester Film

The cellulose ester films of the present invention were manufactured using the following materials according to the following method and selecting ones which are listed in Table 1 and Table 2.

(Preparation of Cellulose Acylate Solution)

1] Cellulose Acylate

Cellulose acylate A was used. The cellulose acylate was dried by heating at 120° C. to make the water content to 0.5% by mass or less, and was used in an amount of 100 parts by mass.

Cellulose Acylate A:

According to the methods described in Japanese Patent Application Laid-Open Nos. H10-45804 and H08-231761, and then a cellulose acylate having the total degree of substitution with acyl group of 2.45 and the degree of substitution with acetyl group of 2.45 was prepared. Specifically, as a catalyst, a sulfuric acid was added (in an amount of 7.8 parts by mass based on 100 parts by mass of the cellulose), and a carboxylic acid was added for acylation at 40° C. Then, the amount of sulfuric acid catalyst, the water content and the aging time were controlled to thereby control the total degree of substitution and the degree of substitution at 6-position. Aging temperature was 40° C. The low-molecular-weight component of the cellulose acylate was removed by cleaning the component away with acetone.

2] Solvent

The following solvent A was used. Each solvent has a water content of 0.2% by mass or less.
Solvent A: dichloromethane/methanol=87/13 (mass ratio)

3] Polyester

The polyesters listed in the following Table 1 were used (Film samples 1 to 8 and 12 to 40: 19 parts by mass, Film samples 9 to 11: 3 parts by mass).

Weight average molecular weight (Mw) of the polyester and the ratio of the component having molecular weight of 500 or less were measured with GPC. The low molecular weight component having molecular weight of 500 or less in the polyester was removed with a distillation process.

TABLE 1

| Poly- | Composition | | | | | GPC | |
|---|---|---|---|---|---|---|---|
| ester | | | | | Terminal | | Existance Ratio of |
| # | TPA | SA | EG | PG | Structure | Mw | Mw 500 or less (%) |
| A | 25.3 | 24.7 | 25 | 25 | Ac | 1394 | 0 |
| B | 25.3 | 24.7 | 25 | 25 | Ac | 610 | 0 |
| C | 25.3 | 24.7 | 25 | 25 | Ac | 850 | 0 |
| D | 25.3 | 24.7 | 25 | 25 | Ac | 1020 | 0 |
| E | 24.0 | 26.0 | 25 | 25 | Ac | 1347 | 0 |
| F | 20.0 | 30.0 | 25 | 25 | Ac | 1315 | 0 |
| G | 35.0 | 15.0 | 25 | 25 | Ac | 1273 | 0 |
| H | 26.8 | 23.2 | 25 | 25 | Ac | 1452 | 0 |
| I | 27.5 | 22.5 | 25 | 25 | Ac | 1338 | 7 |
| J | 27.5 | 22.5 | 25 | 25 | Ac | 1394 | 4 |
| K | 25.9 | 24.1 | 25 | 25 | Ac | 1384 | 7 |
| L | 25.9 | 24.1 | 25 | 25 | Ac | 1456 | 2 |
| M | 24.2 | 25.8 | 25 | 25 | Ac | 1378 | 0 |
| N | 27.5 | 22.5 | 25 | 25 | Ac | 1462 | 14 |
| O | 27.5 | 22.5 | 25 | 25 | Ac | 1725 | 11 |
| P | 27.5 | 22.5 | 25 | 25 | Ac | 2306 | 8 |
| Q | 27.5 | 22.5 | 25 | 25 | Ac | 2825 | 6 |
| R | 27.5 | 22.5 | 25 | 25 | Ac | 2771 | 8 |
| S | 27.5 | 22.5 | 25 | 25 | Ac | 1544 | 9 |
| T | 27.5 | 22.5 | 25 | 25 | Ac | 1580 | 7 |
| U | 27.5 | 22.5 | 25 | 25 | Ac | 1647 | 3 |
| V | 27.5 | 22.5 | 25 | 25 | Ac | 1299 | 14 |
| W | 25.9 | 24.1 | 25 | 25 | Ac | 1347 | 12 |

In Table 1, TPA represents a terephthalic acid, SA represents a succinic acid, EG represents an ethylene glycol, PG represents a 1,2-proplylene glycol and Ac represents an acetic acid. The numbers in the composition represent the ratio of each component (% by mass).

The compounds A to T are also used as the retardation developer.

Discotic Compound

When necessary, the discotic compounds (I-1) and (I-2) were used.

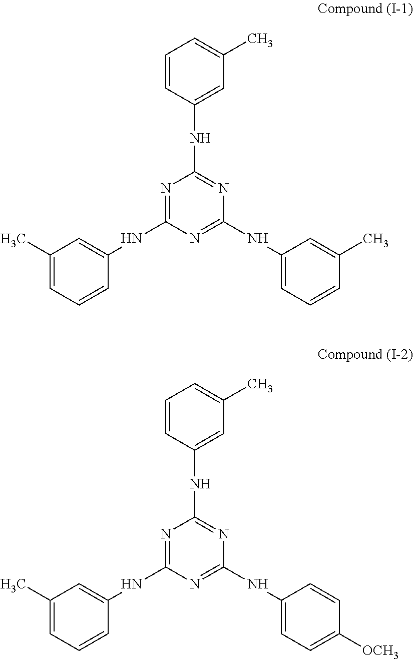

Sugar Ester Compound

When necessary, sugar ester compounds were used.
Silicon dioxide Fine Particle (Particle Size: 20 nm, Moss Hardness: about 7) (0.02 parts by mass)

4] Dissolution

The solvent A and additives (polyester and silicon dioxide fine particle, optionally, discotic compound and sugar ester compound) were introduced into a 4,000 L stainless steel dissolver tank equipped with a stirring blade and the cellulose acylate A was slowly added thereto while the mixture in the tank was dispersed by stirring. After completion of the introduction, the mixture was stirred at room temperature for 2 hours, swollen for 3 hours, and again stirred to obtain a cellulose acylate solution.

For the stirring, a dissolver-type eccentric stirring shaft stirring at a circumferential speed of 5 msec (shear stress 5×10⁴ kgf/m/sec² [4.9×10⁵ N/m/sec²]) and a stirring shaft with an anchor blade was mounted on the central axis thereof, stirring at a circumferential speed of 1 msec (shear stress 1×10⁴ kgf/m/sec² [9.8×10⁴ N/m/sec²]), were used. The swelling was carried out by stopping the high-speed stirring shaft and setting the circumferential speed of the stirring shaft having the anchor blade to 0.5 m/sec. The swollen solution from the tank was then heated to 50° C. through a jacketed pipe and then heated up to 90° C. under a pressure of 1.2 MPa to achieve complete dissolution. The heating time was 15 minutes. In this case, the filter, housing, and piping to be exposed to the high temperature were made of a highly anti-corrosive Hastelloy alloy (registered trademark) and jacketed for circulating a heating medium for heat insulation and heating. Subsequently, the solution was then cooled to 36° C. to obtain a cellulose acylate solution.

The dope thus obtained prior to concentration was flashed in a tank at a normal pressure at 80° C., and the evaporated solvent was recovered and separated with a condenser. The solid concentration of the dope after the flash was 23.5% by mass. Meanwhile, the condensed solvent was returned to the recovering process so as to be reused as a solvent for the preparation process (the recovery is performed by the distillation process, dehydration process, and the like). The dope was defoamed in the flash tank by rotating the shaft equipped with an anchor blade on the central shaft at a circumferential speed of 0.5 msec to stirr the dope. The temperature of the dope in the tank was 25° C., and the average retention time in the tank was 50 min.

5] Filtration

Subsequently, the dope was first passed through a sintered woven metal filter having a nominal pore diameter of 10 μm and then through a sintered woven metal filter having a nominal pore diameter of 10 μm in the same manner. The dope was stored in a 2000 L stainless steel stock tank while the temperature of the dope after the filtration was adjusted to 36° C.

(Preparation of Film)

(Casting)

The dope was cast using a band caster. The film, dried at supply air temperature of 80° C. to 130° C. (exhaust temperature of 75° C. to 120° C.) on the band and then peeled away from the band at the residual solvent amount of 25% by mass to 35% by mass, was stretched to the width direction in a tenter zone of supply air temperature of 140° C. (exhaust temperature in a range of 90° C. to 125° C.) to manufacture a cellulose acylate film. At this time, the casting film thickness was controlled to make the film thickness after stretching become the film thickness listed in Table 2. For the purpose of judging the feasibility of manufacturing, at least 24 rolls of the film having the roll width of 1,280 mm and the roll length of 2,600 mm were fabricated. In one roll out of the 24 rolls of the film fabricated continuously, a sample of 1 m length (width: 1,280 mm) was cut out every 100 m, and used as the cellulose acylate film of each Example and Comparative Example.

For the manufactured film, Re, Rth, ΔRe, internal haze, weight reduction rate and film bleed-out under forced condition were measured, respectively. The results are shown in Table 2.

TABLE 2

| | | | | | | | Film Performance | | | | | | | | | | |
|---|---|---|---|---|---|---|---|---|---|---|---|---|---|---|---|---|---|
| Cellu- | | | | | | | | | | | | Weight | | Film Bleed Out | | | |
| lose | Poly- | | | | Sugar | | Film | | | ΔRe | | Loss | | Under Forced | | | |
| Ester | ester | | Discotic | | Ester | | Thick- | | | (630- | Internal | Rate | | Condition | | Overall | |
| Film | Kind | | Compound | | Compound | | ness | Re | Rth | 440) | Haze | | Judge- | Evalu- | Judge- | Evalu- | |
| # | — | Amt. | Kind | Amt | Kind | Amt. | [μm] | [nm] | [nm] | [nm] | [%] | [%] | ment | ation | ment | ation | Remark |
| 1 | A | 19 | | | | | 59 | 47 | 111 | 3.3 | 0.02 | 0.1 | A | A | ◯ | A | Exam. |
| 2 | A | 19 | (I-1) | 0.8 | | | 58 | 47 | 123 | 1.8 | 0.03 | 0.1 | A | A | ◯ | A | Exam. |
| 3 | A | 19 | (I-1) | 1.3 | | | 45 | 48 | 107 | 1.1 | 0.01 | 0.1 | A | A | ◯ | A | Exam. |
| 4 | A | 19 | (I-1) | 1.8 | | | 45 | 49 | 108 | 0.7 | 0.01 | 0.1 | A | A | ◯ | A | Exam. |
| 5 | A | 19 | (I-1) | 2.4 | | | 45 | 49 | 108 | 0.7 | 0.01 | 0.1 | A | A | ◯ | A | Exam. |
| 6 | A | 19 | (I-2) | 1.3 | | | 45 | 48 | 107 | 1.1 | 0.02 | 0.1 | A | A | ◯ | A | Exam. |
| 7 | A | 19 | (I-1) | 1.3 | | | 40 | 48 | 100 | 0.1 | 0.02 | 0.1 | A | A | ◯ | A | Exam. |
| 8 | A | 19 | (I-1) | 1.3 | | | 50 | 48 | 107 | 1.5 | 0.04 | 0.1 | A | A | ◯ | A | Exam. |
| 9 | A | 3 | | | (A-5) | 8 | 40 | 47 | 123 | 1.8 | 0.02 | 0.1 | A | A | ◯ | A | Exam. |
| 10 | A | 3 | | | (A-6) | 8 | 40 | 48 | 125 | 1.9 | 0.02 | 0.1 | A | A | ◯ | A | Exam. |
| 11 | A | 3 | | | (A-7) | 8 | 40 | 47 | 124 | 1.8 | 0.02 | 0.1 | A | A | ◯ | A | Exam. |
| 12 | B | 19 | | | | | 55 | 39 | 90 | 3.9 | 0.04 | 0.1 | A | A | ◯ | A | Exam. |
| 13 | C | 19 | | | | | 55 | 42 | 98 | 3.7 | 0.04 | 0.1 | A | A | ◯ | A | Exam. |
| 14 | D | 19 | | | | | 55 | 45 | 104 | 3.5 | 0.04 | 0.1 | A | A | ◯ | A | Exam. |
| 15 | E | 19 | | | | | 55 | 72 | 130 | 3.0 | 0.04 | 0.1 | A | A | ◯ | A | Exam. |
| 16 | F | 19 | | | | | 55 | 71 | 120 | 3.4 | 0.04 | 0.1 | A | A | ◯ | A | Exam. |
| 17 | G | 19 | | | | | 55 | 79 | 150 | 2.5 | 0.04 | 0.1 | A | A | ◯ | A | Exam. |
| 18 | H | 19 | | | | | 55 | 75 | 135 | 2.8 | 0.04 | 0.1 | A | A | ◯ | A | Exam. |
| 19 | I | 19 | | | | | 55 | 71 | 134 | 2.8 | 0.04 | 0.4 | B | A | ◯ | B | Exam. |
| 20 | J | 19 | | | | | 55 | 74 | 138 | 2.6 | 0.04 | 0.2 | A | A | ◯ | A | Exam. |
| 21 | K | 19 | | | | | 55 | 67 | 130 | 3.1 | 0.04 | 0.3 | B | A | ◯ | B | Exam. |
| 22 | L | 19 | | | | | 55 | 66 | 133 | 3.0 | 0.04 | 0.1 | A | A | ◯ | A | Exam. |
| 23 | M | 19 | | | | | 55 | 65 | 125 | 3.1 | 0.04 | 0.2 | A | A | ◯ | A | Exam. |
| 24 | N | 19 | | | | | 55 | 73 | 136 | 2.8 | 0.03 | 0.9 | D | A | ◯ | D | Comp. |
| | | | | | | | | | | | | | | | | | Exam. |
| 25 | N | 19 | (I-1) | 0.8 | | | 58 | 47 | 123 | 1.8 | 0.03 | 0.9 | D | A | ◯ | D | Comp. |
| | | | | | | | | | | | | | | | | | Exam. |
| 26 | N | 19 | (I-1) | 1.3 | | | 45 | 48 | 107 | 1.1 | 0.01 | 0.9 | D | A | ◯ | D | Comp. |
| | | | | | | | | | | | | | | | | | Exam. |
| 27 | N | 19 | (I-1) | 1.8 | | | 45 | 49 | 108 | 0.7 | 0.01 | 0.9 | D | A | ◯ | D | Comp. |
| | | | | | | | | | | | | | | | | | Exam. |
| 28 | N | 19 | (I-1) | 2.4 | | | 45 | 49 | 108 | 0.7 | 0.01 | 0.9 | D | A | ◯ | D | Comp. |
| | | | | | | | | | | | | | | | | | Exam. |
| 29 | N | 19 | (I-2) | 1.3 | | | 45 | 48 | 107 | 1.1 | 0.02 | 0.9 | D | A | ◯ | D | Comp. |
| | | | | | | | | | | | | | | | | | Exam. |
| 30 | N | 19 | (I-1) | 1.3 | | | 40 | 48 | 100 | 0.1 | 0.02 | 0.9 | D | A | ◯ | D | Comp. |
| | | | | | | | | | | | | | | | | | Exam. |
| 31 | N | 19 | (I-1) | 1.3 | | | 50 | 48 | 107 | 1.5 | 0.04 | 0.9 | D | A | ◯ | D | Comp. |
| | | | | | | | | | | | | | | | | | Exam. |
| 32 | O | 19 | | | | | 55 | 80 | 140 | 2.7 | 0.04 | 0.7 | C | B | X | D | Comp. |
| | | | | | | | | | | | | | | | | | Exam. |
| 33 | P | 19 | | | | | 55 | 64 | 149 | 2.6 | 0.04 | 0.4 | C | C | X | D | Comp. |
| | | | | | | | | | | | | | | | | | Exam. |
| 34 | Q | 19 | | | | | 55 | 65 | 158 | 2.3 | 0.04 | 0.2 | A | D | X | D | Comp. |
| | | | | | | | | | | | | | | | | | Exam. |
| 35 | R | 19 | | | | | 55 | 100 | 137 | 2.3 | 0.04 | 0.2 | A | D | X | D | Comp. |
| | | | | | | | | | | | | | | | | | Exam. |
| 36 | S | 19 | | | | | 55 | 79 | 144 | 2.7 | 0.04 | 0.8 | C | C | X | D | Comp. |
| | | | | | | | | | | | | | | | | | Exam. |
| 37 | T | 19 | | | | | 55 | 69 | 144 | 2.6 | 0.04 | 0.3 | B | D | X | D | Comp. |
| | | | | | | | | | | | | | | | | | Exam. |
| 38 | U | 19 | | | | | 55 | 75 | 144 | 2.6 | 0.04 | 0.2 | A | D | X | D | Comp. |
| | | | | | | | | | | | | | | | | | Exam. |
| 39 | V | 19 | | | | | 55 | 67 | 134 | 2.7 | 0.04 | 0.7 | C | A | ◯ | C | Comp. |
| | | | | | | | | | | | | | | | | | Exam. |
| 40 | W | 19 | | | | | 55 | 66 | 128 | 3.1 | 0.04 | 0.5 | C | A | ◯ | C | Comp. |
| | | | | | | | | | | | | | | | | | Exam. |

In Table 2, the amount of each component to be added represents “part by mass”.

The overall evaluation in Table 2 was conducted according to the following criteria.

A: weight reduction rate is A and bleed out is O

B: weight reduction rate is B and bleed out is O

C: weight reduction rate is C and bleed out is O

D: any one of weight reduction rate and bleed out is X

As shown in Table 2, the cellulose ester film of the present invention showed low weight reduction rate, good surface-state of the film and suppressed bleed-out.

[Manufacture of Polarizing Plate]

Iodine was adsorbed to the stretched polyvinyl alcohol film to produce a polarizer. Each cellulose acylate film of Examples and Comparative Examples thus manufactured was bonded to one side of the polarizer using a polyvinyl alcohol-based adhesive. Saponification was performed under the following conditions.

1.5 mol/L Aqueous solution of sodium hydroxide was prepared and the temperature was controlled at 55° C. 0.005 mol/L aqueous solution of diluted sulfuric acid was prepared and the temperature was controlled at 35° C. The manufactured cellulose acylate film was immersed in the aqueous sodium hydroxide solution for 2 min, and then the film was immersed in water to sufficiently wash away the aqueous sodium hydroxide solution. Then, the film was immersed in the aqueous solution of dilute sulfuric acid for 1 min, and then the film was immersed in water to sufficiently wash away the aqueous solution of diluted sulfuric acid. Finally, the sample was sufficiently dried at 120° C.

A commercially available cellulose triacylate film (FUJITAC TD80UF, manufactured by FUJI Film Corporation) was saponified, then bonded to the opposite side of the polarizer using the polyvinyl alcohol-based adhesive, and then dried at 70° C. for 10 min or more.

The slow axis of the cellulose acylate film in each of Examples and Comparative Examples was arranged parallel to the transmission axis of the polarizer, and the slow axis of the commercially available cellulose triacylate film was arranged perpendicular to the transmission axis of the polarizer.

[Manufacture of Liquid Crystal Display Device]

Liquid crystal display device of VA mode was manufactured by using a polarizing plate using a cellulose acylate film of each of Examples according to the configuration illustrated in FIG. 2 of Japanese Patent Application Laid-Open No. 2008-262161. As a result, it was confirmed that the liquid crystal display device has low color shift and high contrast.

What is claimed is:

1. A cellulose ester film comprising:
at least one polyester; and
a cellulose ester having a degree of substitution of 2.0 to 2.6,
wherein a weight average molecular weight of the polyester is 1,500 or less, and a ratio of components having a molecular weight of 500 or less in the polyester is less than 8%.

2. The cellulose ester film of claim 1, wherein the polyester is a polycondensation ester of a mixture of an aromatic dicarboxylic acid and an aliphatic dicarboxylic acid; and an aliphatic diol.

3. The cellulose ester film of claim 2, wherein each terminal of the polyester is an ester derivative of an aliphatic monocarboxylic acid.

4. The cellulose ester film of claim 2, wherein the aliphatic diol has an average carbon atom number of 2 to 3.

5. The cellulose ester film of claim 2, wherein the aliphatic dicarboxylic acid has an average carbon atom number of 4 to 6, and a mixing ratio of the aromatic dicarboxylic acid in the mixture of an aromatic dicarboxylic acid and an aliphatic dicarboxylic acid is 20% by mass to 70% by mass.

6. The cellulose ester film of claim 1, wherein the cellulose ester is a cellulose acylate.

7. The cellulose ester film of claim 1, which satisfies a following Equation (I):
ΔRe>0
wherein ΔRe=Re(630)−Re(430) and Re(630) represents an in-plane retardation at the wavelength of 630 nm; and Re(430) represents an in-plane retardation at the wavelength of 430 nm.

8. The cellulose ester film of claim 1, wherein an in-pane retardation at the wavelength of 590 nm (Re(590)) is 30 nm<Re(590)<100 nm, and a retardation in a thickness-direction at the wavelength of 590 nm (Rth(590)) is 80 nm<Rth(590)<300 nm.

9. The cellulose ester film of claim 1, which has a weight reduction rate of less than 0.4% when the cellulose ester film is kept at 180° C. for 1 hour.

10. The cellulose ester film of claim 1, which has an internal haze of 0.2% or less.

11. The cellulose ester film of claim 1, which comprises at least one retardation developer.

12. The cellulose ester film of claim 11, wherein the retardation developer includes a discotic compound, and the discotic compound is in an amount of less than 3 parts by mass based on 100 parts by mass of the cellulose ester.

13. The cellulose ester film of claim 11, wherein the retardation developer includes an ester compound having 1 to 12 units of at least one of a pyranose structure and a furanose structure, in which a part of hydroxyl groups in the least one of the pyranose structure and the furanose structure is esterified, and the ester compound is in an amount of less than 15 parts by mass based on 100 parts by mass of the cellulose ester.

14. A polarizing plate comprising a cellulose ester film of claim 1.

15. A liquid crystal display device comprising a polarizing plate of claim 14.
